(19) United States
(12) Patent Application Publication
(10) Pub. No.: US 2018/0187079 A1
(43) Pub. Date: Jul. 5, 2018

(54) COMPOSITION AND LIQUID CRYSTAL DISPLAY DEVICE USING THE SAME

(71) Applicant: DIC Corporation, Tokyo (JP)

(72) Inventors: Gou SUDOU, Kita-adachi-gun (JP); Kazuki KURISAWA, Kita-adachi-gun (JP)

(73) Assignee: DIC Corporation, Tokyo (JP)

(21) Appl. No.: 15/740,618

(22) PCT Filed: Jun. 23, 2016
(86) PCT No.: PCT/JP2016/068662

§ 371 Date: Feb. 1, 2018

(30) Foreign Application Priority Data
Jul. 1, 2015 (JP) 2015-132698

(51) Int. Cl. C09K 19/42; C09K 19/32; C09K 19/30; C09K 19/54; C09K 19/14; G02F 1/137; G02F 1/1362

(52) U.S. Cl. CPC C09K 19/42; C09K 2019/3425; C09K 19/3066; C09K 19/54; C09K 19/14; G02F 1/137; G02F 1/1362; G02F 2001/13712; C09K 2019/303; C09K 2019/3004; C09K 2019/3006; C09K 2019/301; C09K 2019/3013; C09K 2019/3018; C09K 2019/3021; C09K 19/322

(57) ABSTRACT

[Object] An object to be achieved by the present invention is to provide a liquid crystal display device that uses a liquid crystal composition having negative dielectric anisotropy, in which the liquid crystal composition can realize excellent display properties when used in the liquid crystal display device without degrading the image-sticking properties of the display device while realizing various liquid crystal display properties such as dielectric anisotropy, viscosity, nematic phase upper limit temperature, low-temperature nematic phase stability, γ₁, etc. [Solution] A liquid crystal composition is characterized in that it contains, as a first component, at least one compound selected from the group consisting of compounds represented by general formula (i), and, as a second component, at least one compound selected from the group consisting of compounds represented by general formula (ii).

### TECHNICAL FIELD

The present invention relates to a composition that has a negative dielectric anisotropy (Δε) and is useful as a liquid crystal display material, and to a liquid crystal display device using the composition.

### BACKGROUND ART

Active matrix liquid crystal display devices are commercially available in the market of portable terminals, liquid crystal televisions, projectors, computers, etc., due to their excellent display quality. The active matrix system uses a thin film transistor (TFT), a metal-insulator-metal (MIM), or the like in each pixel, and it is particularly important that the liquid crystal compound or the liquid crystal composition used in this system have a high voltage holding ratio. In order to obtain wider viewing angle properties, there have been proposed liquid crystal display devices combined with vertical alignment (VA) mode, in-plane-switching (IPS) mode, fringe field switching (FFS) mode, which is a type of the IPS mode, or optically compensated bend (OCB, optically compensated birefringence) mode; furthermore, in order to obtain brighter displays, reflection-type liquid crystal display devices of electrically controlled birefringence (ECB) mode have been proposed. In order to comply with such liquid crystal display devices, proposals of new liquid crystal compounds and liquid crystal compositions are being made even now.

Liquid crystal compositions having negative Δε are widely used in vertical alignment displays (VA and PSVA mode, etc.) and horizontal alignment displays (IPS and FFS mode, etc.) of liquid crystal televisions, portable terminals, etc., and all of these driving modes including the aforementioned modes require low-voltage drive, high-speed response, and a wide operation temperature range. In other words, a negative Δε with a large absolute value, a low viscosity (η), and a high nematic phase-isotropic liquid phase transition temperature (Tₙᵢ) are required. Moreover, in order to set the product of Δn and the cell gap (d), i.e., Δn×d, the Δn of the liquid crystal composition must be adjusted to be in an appropriate range. Furthermore, when the liquid crystal display device is adapted to televisions, smart phones, etc., high-speed response is important and thus a liquid crystal composition having a low γ₁ is required.

For example, PTL 1 attempts to decrease γ₁ by using a compound having a dialkyl bicyclohexane skeleton; however, the vapor pressure of this compound is high, and, in general, this tendency is particularly notable in compounds having short alkyl chain lengths. Furthermore, since compounds having dialkyl bicyclohexane skeletons tend to also have a low Tₙᵢ, compounds having a side chain having a total of 7 or more carbon atoms are frequently used, and sufficient studies have not been made on compounds having short side chain lengths under current circumstances. Thus, PTL 2 has focused on the side chain length and the side chain groups of bicyclohexane compounds and attempted to decrease γ₁ by using a compound having a dialkenyl bicyclohexane skeleton.

### CITATION LIST

### Patent Literature

PTL 1: Japanese Unexamined Patent Application Publication (Translation of PCT Application) No. 2008-505235

PTL 2: International Publication No. 2014/155533 pamphlet

### SUMMARY OF INVENTION

### Technical Problem

When a compound having a dialkenyl bicyclohexane skeleton and a particular liquid crystal composition having negative Δε are used in combination as in PTL 2, an effect of decreasing γ₁ as the liquid crystal composition as a whole is confirmed. However, the compatibility of the liquid crystal composition and Tₙᵢ of the liquid crystal composition as a whole are degraded, and there is need to limit, to some extent, the types of the compound having a dialkenyl bicyclohexane skeleton and the liquid crystal compound having negative Δε, and the contents of other compounds having a viscosity-decreasing effect; thus, improvements are demanded so that the effect of decreasing γ₁ of the liquid crystal composition as a whole is more notably exhibited. Thus, an object of the present invention is to provide a liquid crystal compound having negative Δε to address the problems described above.

### Solution to Problem

The inventors of the present invention have studied various liquid crystal compounds and various chemical substances and found that the problems described above can be resolved by combining particular liquid crystal compounds; thus, the present invention has been made.

Provided are a composition containing a compound represented by general formula (i) and a compound represented by general formula (ii), a liquid crystal display device that uses the composition, and a liquid crystal, display device that uses the liquid crystal composition.

### Advantageous Effects of Invention

A composition having negative dielectric anisotropy according to the present invention can exhibit a significantly low viscosity, has excellent low-temperature solubility, and undergoes very little changes in resistivity and voltage holding ratio under heating or light irradiation; thus, practicality of the product is high, and liquid crystal display devices of VA mode, FFS mode, etc., that use this composition can achieve high-speed response.

Since the performance of the composition is stable during the process of producing a liquid crystal display device that includes the liquid crystal composition of the present invention, display defects attributable to production process are suppressed, and high-yield production is possible, which makes the composition highly useful.

When the composition of the present invention is combined with a liquid crystal display device of IPS or FFS mode, high transmittance and high-speed response can be obtained.

### DESCRIPTION OF EMBODIMENTS

The composition of the present invention preferably takes a liquid crystal phase at room temperature (25° C.) and more preferably takes a nematic phase. The composition of the present invention contains a compound substantially dielectrically neutral (the value of Δε is −2 to 2) and a compound dielectrically negative (the value of Δε is smaller than −2). It should be noted that Δε of the compound is a value obtained by extrapolation from an observed dielectric anisotropy value of a composition prepared by adding the compound to a composition that is substantially dielectrically neutral at 25° C. In the description below, the content is indicated by “%”, and “%” means % by mass.

A first aspect of the present invention provides a liquid crystal composition that contains one or two or more compounds represented by general formula (i):

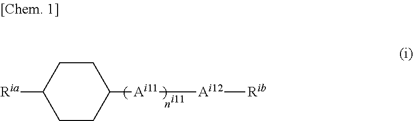

(in general formula (i), R^{ia} and R^{ib} each independently represent an alkenyl group having 2 to 8 carbon atoms, Aⁱ¹¹ and Aⁱ¹² each independently represent a group selected from the group consisting of the following group (a) and group (b):
(a) a 1,4-cyclohexylene group (one —CH₂— or two or more non-adjacent —CH₂— present in this group may each be substituted with —O—)
(b) a 1,4-phenylene group (one —CH═ or two or more non-adjacent —CH═ present in this group may each be substituted with —N═)
where the group (a) and the group (b) may each independently be substituted with a cyano group, a fluorine atom, or a chlorine atom, and
nⁱ¹¹ represents an integer of 0 to 3, and when nⁱ¹¹ represents 2 or 3 and multiple Aⁱ¹¹ are present, they may be the same or different); and
one or two or more compounds represented by general formula (ii):

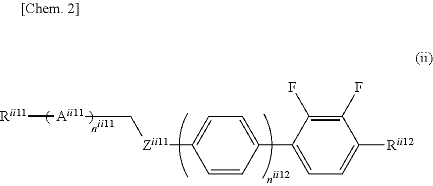

(in general formula (ii), Rⁱⁱ¹¹ and Rⁱⁱ¹² each independently represent an alkyl group having 1 to 8 carbon atoms, one —CH₂— or two or more non-adjacent —CH₂— in the alkyl group may each independently be substituted with —CH═CH—, —C═C—, —O—, —CO—, —COO—, or OCO—,
Aⁱⁱ¹¹ represents a group selected from the group consisting of the following group (a) and group (b):
(a) a 1,4-cyclohexylene group (one —CH₂— or two or more non-adjacent —CH₂— present in this group may each be substituted with —O—)
(b) a 1,4-phenylene group (one —CH═ or two or more non-adjacent —CH═ present in this group may each be substituted with —N═)
where the group (a) and the group (b) may each independently be substituted with a cyano group, a fluorine atom, or a chlorine atom, and
zⁱⁱ¹¹ represents —CH₂— or —O—,
nⁱⁱ¹¹ represents an integer of 0 to 3, and
nⁱⁱ¹¹ represents an integer of 0 to 3, and when nⁱⁱ¹¹ represents 2 or 3 and multiple Aⁱ¹¹ are present, they may be the same or different).

The liquid crystal composition of the present invention has a low viscosity and significantly improved response speed since it contains a compound represented by general formula (i) and a compound represented by general formula (ii). Specifically, compared to the case where, instead of the compound represented by general formula (i), the same amount of multiple compounds each having an alkenyl group on one side are mixed, using the compound represented by general formula (i) can realise a liquid crystal composition that has low viscosity and is suitable for use in high-speed-response liquid crystal display devices.

The liquid crystal composition of the present invention has a refractive index anisotropy (Δn) at 25° C. of 0.06 to 0.20, preferably 0.07 to 0.18, and more preferably 0.08 to 0.16. More specifically, the refractive index anisotropy is preferably 0.11 to 0.14 to comply with a small cell gap or preferably 0.08 to 0.11 to comply with a large cell gap.

The liquid crystal composition of the present invention preferably has a dielectric anisotropy (Δε) at 25° C. of −12 to −2, more preferably −10 to −2.5, and yet more preferably −8 to −3.

The nematic phase-isotropic liquid phase transition temperature (Tₙᵢ) of the liquid crystal composition of the present invention is 60° C. to 120° C., but is more preferably 70° C. to 110° C. and yet more preferably 70° C. to 100° C.

The viscosity (η) of the liquid crystal composition of the present invention at 25° C. is 5 to 55 mPa·s, but is preferably 7 to 54 mPa·s or less, and more preferably 1.0 to 50 mPa·s or less.

The rotational viscosity (γ₁) of the liquid crystal

composition of the present invention at 25° C. is 20 to 200 mPa·s, but is preferably 150 mPa·s or less, more preferably: 100 mPa·s or less, and yet more preferably 95 mPa·s or less.

In the description below, the compounds represented by general formulae (i) and (ii), which are essential components of the liquid crystal composition of the present invention, are described in detail, and then other liquid crystal compounds suitable for use in the liquid crystal composition of the present invention are described.

The compound represented by general formula (i) according to the present invention is preferably a compound that is substantially dielectrically neutral (the value of Δε is −2 to 2).

In general formula (i), R^{ia} and R^{ib} each independently represent an alkenyl group having 2 to 8 carbon atoms, and are each preferably linear or branched, and more preferably linear. A linear alkenyl group having 2 to 6 carbon atoms is more preferable, and a linear alkenyl group having 2 or 3 carbon atoms is yet more preferable.

The alkenyl group that is more preferable in the present invention is preferably selected from the groups represented by formula (R1) to formula (R5) (in each formula, the dot represents a carbon atom in the ring structure).

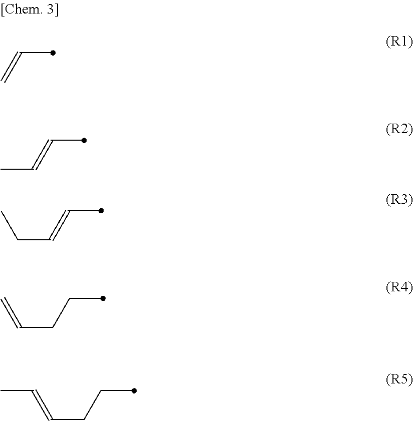

These formulae represent alkenyl groups.

In general formula (i) of the present invention, R^{ia} and R^{ib} are preferably each independently formula (R1), formula (R2), or formula (R4), and more preferably formula (R1) or formula (R2).

The examples of the alkenyl groups are shared throughout the description, and a suitable alkenyl group is selected from among these example groups according to the number of carbon atoms in the alkyl group.

The compound represented by general formula (i) according to the present invention has alkenyl groups as the groups on both sides and thus exhibits a synergetic effect for decreasing viscosity or enhancing response speed.

In general formula (i), Aⁱ¹¹ and Aⁱ¹² each independently represent a group selected from the group consisting of a 1,4-cyclohexylene group and a 1,4-phenylene group, and this group may each independently be substituted with a fluorine atom. When Aⁱ¹² represents a 1,4-phenylene group, R^{ib} is more preferably a group selected from (R4) and (R5).

In general formula (i) above, nⁱ¹¹ preferably represents an integer of 0 to 2, nⁱ¹¹ more preferably represents an integer of 0 or 1, and nⁱ¹¹ yet more preferably represents 0. In other words, the compound represented by formula (i) is preferably a compound having 2 to 4 rings, is preferably a compound having 2 or 3 rings, and more preferably is a compound having 2 rings.

The compound represented by general formula (i) preferably has two cyclohexane rings in the molecule. Thus, in general formula (i), one group selected from the group consisting of nⁱ¹¹ Aⁱ¹¹ and Aⁱ¹² is preferably a 1,4-cyclohexylene group, and particularly preferably Aⁱ¹² represents a 1,4-cyclohexylene group.

The preferable lower limit of the content of the compound represented by formula (i) relative to the total of the composition of the present invention is 1%, 2%, 3%, 5%, 7%, 8%, 10%, 13%, 15%, 17%, 20%, 23%, 25%, 30%, 31%, 32%, or 33%. It is also 34%, 36%, 38%, or 39%. The preferable upper limit of the content relative to the total of the composition of the present invention is 65%, 63%, 60%, 58%, 57%, 55%, 53%, 52%, 50%, 48%, 40%, 37%, 35%, 33%, 30%, 27%, 25%, 23%, 20%, 17%, 15%, 13%, 12%, or 10%.

The compound represented by general formula (i) is preferably a compound represented by general formula (i-a) below:

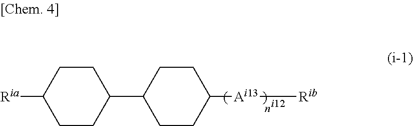

(In general formula (i-a), R^{ia} and R^{ib} each independently represent an alkenyl group having 2 to 5 carbon atoms, Aⁱ¹³ represents a group selected from the group consisting of the following group (a) and group (b):
(a) a 1,4-cyclohexylene group (one —CH₂— or two or more non-adjacent —CH₂— present in this group may each be substituted with —O—)
(b) a 1, 4-phenylene group (one —CH═ or two or more non-adjacent —CH═ present in this group may each be substituted with —N═)
where the group (a) and the group (b) may each independently be substituted with a cyano group, a fluorine atom, or a chlorine atom, and
nⁱ¹² represents an integer of 0 or 1.)

When nⁱ¹² represents 1, Aⁱ¹³ preferably represents a 1,4-phenylene group, and in general formula (i-a), nⁱ¹² particularly preferably represents 0. When a structure includes cyclohexane rings directly bonded to each other and alkenyl groups at both terminals, the elastic constant is improved, and a liquid crystal composition having low viscosity can be realized. As a result, a liquid crystal composition combined with general formula (ii) can realize high-speed response and low viscosity.

The preferable lower limit of the content of the compound represented by general formula (i-a) relative to the total of the composition of the present invention is 1%, 2%, 3%, 5%, 7%, 8%, 10%, 13%, 15%, 17%, 20%, 23%, 25%, 30%, 31%, 32%, or 33%. It is also 34%, 36%, 38%, or 39%. The preferable upper limit of the content relative to the total of the composition of the present invention is 65%, 63%, 60%, 58%, 57%, 55%, 53%, 52%, 50%, 48%, 40%, 31%, 35%, 33%, 30%, 27%, 25%, 23%, 20%, 17%, 15%, 13%, 12%, or 10%.

The compound represented by general formula (i) of the present invention is preferably one or two or more compounds selected from the group consisting of compounds represented by general formulae (i-1) to ( i-5).

The compound represented by general formula (i) is preferably a compound selected from the group consisting of compounds represented by general formula (i-1).

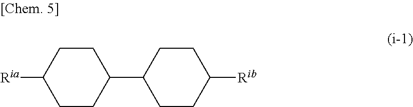

(In the formula, R^{ia} and R^{ib} each independently represent an alkenyl group having 2 to 8 carbon atoms.)

In general formula (i-1), R^{ia} and R^{ib} preferably each independently represent a linear alkenyl group having 2 to 5 carbon atoms.

The preferable lower limit of the content of the compound represented by formula (i-1) relative to the total of the composition of the present invention is 1%, 5%, 10%, 13%, 15%, 17%, 20%, 23%, 25%, or 30%. The preferable upper limit of the content, relative to the total of the composition of the present invention is 60%, 55%, 50%, 45%, 40%, 37%, 35%, 33%, 30%, 27%, 25%, 23%, 20%, 17%, 15%, 13%, or 10%.

The compound represented by general formula (i-1) is preferably a compound selected from the group consisting of compounds represented by formula (i-1.1) to formula (i-1.15), is more preferably a compound selected from the group consisting of compounds represented by formula (i-1.1) to formula (i-1.5), formula (i-1.7), formula (i-1.8) and formula (i-1.14), and is particularly preferably a compound selected from the group consisting of compounds represented by formula (i-1.1), formula (i-1.2), and formula (i-1.4).

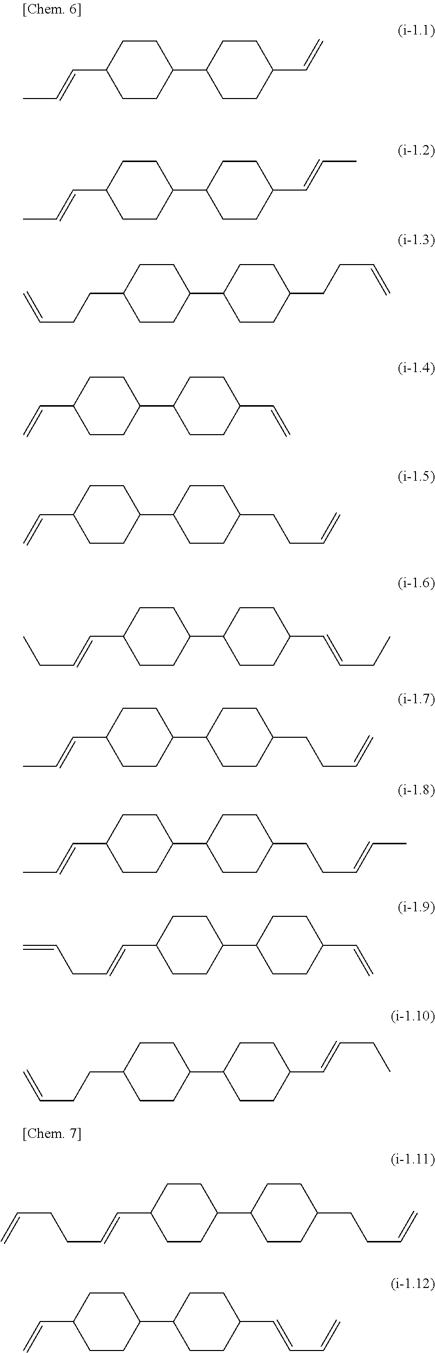

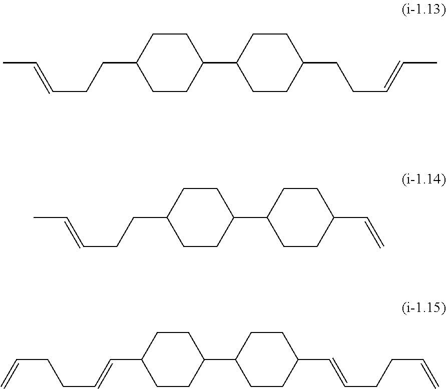

In particular, the compounds represented by (i-1.1) and (i-1.4) are preferable since they particularly improve the response speed of the composition of the present invention. When high Tni is desirable rather than the response speed, the compounds represented by formula (i-1.2), formula (i-1.3), formula (i-1.7), and formula (i-1.8) are preferably used. In order to improve the low-temperature solubility, the compounds represented by formula (i-1.1), formula (i-1.3), formula (i-1.4) and formula (i-1.5) are preferable. In order to obtain low viscosity and improve the value of the elastic constant K33, the compounds represented by formula (i-1.1), formula (i-1.2), and formula (i-1.4) are preferable. Rather than a composition obtained by separately mixing a compound having low viscosity and a compound that improves the value of the elastic constant K33, more synergy is effected by using the compounds represented by formula (i-1.1), formula (i-1.2), and formula (i-1.4).

The compound represented by general formula (i) is a compound represented by general formula (i-2) below:

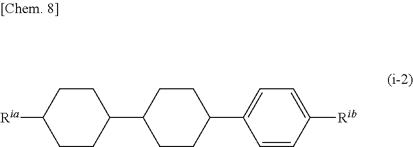

(In the formula, R^{ia} and R^{ib} each independently represent an alkenyl group having 2 to 8 carbon atoms.)

In general formula (i-2), R^{ia} and R^{ib} preferably each independently represent a linear alkenyl group having 2 to 5 carbon atoms.

The preferable lower limit of the content of the compound represented by formula (i-2) relative to the total of the composition of the present invention is 1%, 5%, 10%, 13%, 15%, 17%, 20%, 23%, 25%, or 30%. The preferable upper limit of the content relative to the total of the composition of the present invention is 60%, 55%, 50%, 45%, 40%, 37%, 35%, 33%, 30%, 27%, 25%, 23%, 20%, 17%, 15%, 13%, or 10%.

The compound represented by general formula (i-2) is preferably a compound selected from the group consisting of compounds represented by formula (i-2.1) to formula (i-2.8), and is more preferably a compound selected from the group consisting of compounds represented by formula (i-2.1), formula (i-2.2), formula (i-2.5), and formula (i-2.6).

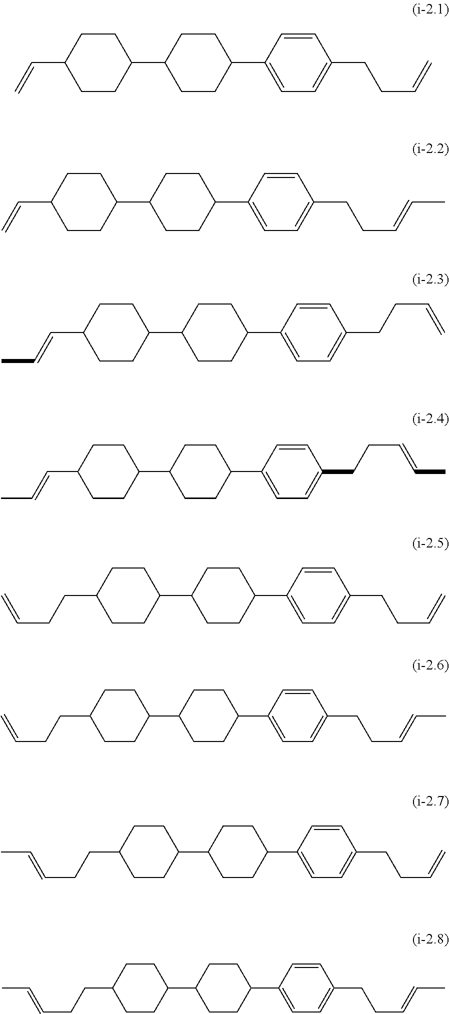

The compound represented by general formula (i) is preferably a compound represented by general formula (i-3) below:

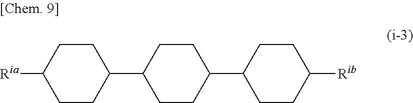

(In the formula, R^{ia} and R^{ib} each independently represent an alkenyl group having 2 to 8 carbon atoms.)

In general formula (i-3), R^{ia} and R^{ib} preferably each independently represent a linear alkenyl group having 2 to 5 carbon atoms.

The preferable lower limit of the content of the compound represented by formula (i-3) relative to the total of the composition of the present invention is 1%, 5%, 10%, 13%, 15%, 17%, 20%, 23%, 25%, or 30%. The preferable upper limit of the content relative to the total of the composition of the present invention is 60%, 55%, 50%, 45%, 40%, 37%, 35%, 33%, 30%, 27%, 25%, 23%, 20%, 17%, 15%, 13%, or 10%.

The compound represented by general formula (i-3) is preferably a compound selected from the group consisting of compounds represented by formula (i-3.1) to formula (i-3.3).

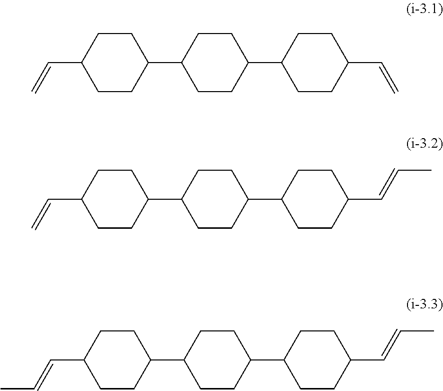

The compound represented by general formula (i) is preferably a compound represented by general formula (i-4) below:

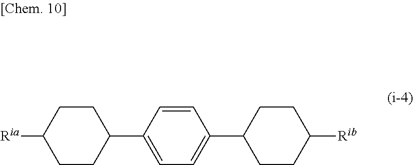

(In the formula, R^{ia} and R^{ib} each independently represent an alkenyl group having 2 to 8 carbon atoms.)

In general formula (i-4), R^{ia} and R^{ib} preferably each independently represent a linear alkenyl group having 2 to 5 carbon atoms.

The preferable lower limit of the content of the compound represented by formula (i-4) relative to the total of the composition of the present invention is 1%, 5%, 10%, 13%, 15%, 17%, 20%, 23%, 25%, or 30%, The preferable upper limit of the content relative to the total of the composition of the present invention is 60%, 55%, 50%, 45%, 40%, 37%, 35%, 33%, 30%, 27%, 25%, 23%, 20%, 17%, 15%, 13%, or 10%.

The compound represented by general formula (i-4) is preferably a compound selected from the group consisting of compounds represented by formula: (i-4.1) to formula (i-3), and is more preferably a compound represented by formula (i-4.1).

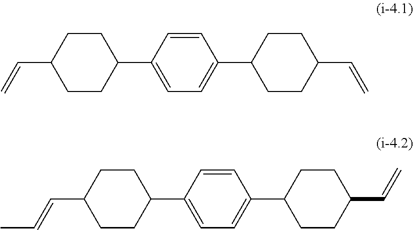

The compound represented by general formula (i) is preferably a compound represented by general formula (i-5) below:

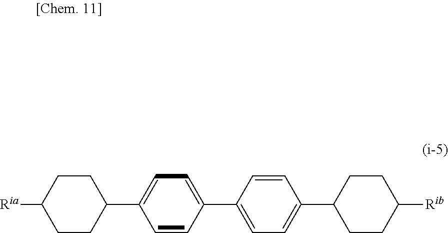

(In the formula, R^{ia} and R^{ib} each independently represent an alkenyl group having 2 to 8 carbon atoms.)

In general formula (i-5), R^{ia} and R^{ib} preferably each independently represent a linear alkenyl group having 2 to 5 carbon atoms.

The preferable lower limit of the content of the compound represented by formula (i-5) relative to the total of the composition of the present invention is 1%, 5%, 10%, 13%, 15%, 17%, 20%, 23%, 25%, or 30%. The preferable upper limit of the content relative to the total of the composition of the present invention is 60%, 55%, 50%, 45%, 40%, 37%, 35%, 33%, 30%, 27%, 25%, 23%, 20%, 17%, 15%, 13%, or 10%.

The compound represented by general formula (i-5) is preferably a compound selected from the group consisting of compounds represented by formula (i-5.1) to formula (i-5.3).

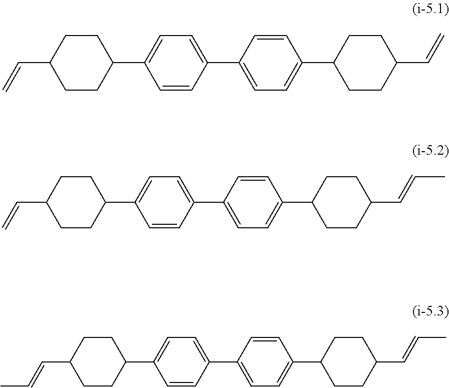

The compound represented by general formula (ii) according to the present invention is preferably a compound that is negative (the value of Δε is smaller than −2).

Is general formula (ii), Rⁱⁱ¹¹ preferably represents an alkyl group having 1 to 8 carbon atoms or an alkenyl group having 2 to 8 carbon atoms, and preferably represents a linear alkyl group having 1 to 5 carbon atoms or a linear alkenyl group having 2 to 5 carbon atoms.

In general formula (ii), Rⁱⁱ¹² preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, and preferably represents a linear alkoxy group having 1 to 5 carbon atoms, a linear alkenyl group having 2 to 5 carbon atoms, or a linear alkenyloxy group having 2 to 5 carbon atoms.

In general formula (ii), Aⁱⁱ¹¹ preferably represents a 1,4-cyclohexylene group (one —CH₂— or two or more non-adjacent —CH₂— in the group may each be substituted with —O—) or a 1,4-phenylene group, and hydrogen atoms in the 1,4-phenylene group may each independently be substituted with a fluorine atom. When nⁱⁱ¹¹ represents 2 or more, Aⁱⁱ¹¹ may be the same or different. In general formula (ii), Aⁱⁱ¹¹ preferably represents 1,4-cyclohexylene group or a 1,4-phenylene group; and when Zⁱⁱ¹¹ represents —O—, a 1,4-cyclohexylene group is more preferable.

In general formula (ii), preferably represents —CH₂— or —O—.

In general formula (ii), nⁱⁱ¹¹ preferably represents 0, 1, or 2, and

when nⁱⁱ¹¹ represents 2 or more and multiple Aⁱⁱ¹¹ are present, they may be the same or different; more preferably, nⁱⁱ¹¹ represents 1 or 2.

In general formula (ii), nⁱⁱ¹² preferably represents 0, 1, or 2. From the viewpoints of the dielectric anisotropy and high-speed response, nⁱⁱ¹² preferably represents 0.

The preferable lower limit of the content of the compound represented by general formula (ii) relative to the total of the liquid crystal composition of the present invention is 1%, 2%, 4%, 5%, 8%, 10%, 13%, 15%, 18%, 20%, 23%, 25%, 28%, 30%, 32%, 35%, 37%, or 40%. The preferable upper limit of the content is 70%, 65%, 60%, 55%, 50%, 45%, 43%, 40%, 35%, 32%, 30%, 35%, 32%, 30%, 35%, 32%, 30%, 35%, 32%, 30%, 28%, 25%, 23%, 20%, 18%, 15%, 13%, 10%, 8%, or 5%.

The compound represented by general formula (ii) is preferably a compound selected from the group consisting of compounds represented by general formulae (ii-1) to (ii-11), is more preferably compounds represented by general formula (ii-1) to general formula (i-4), and is yet more preferably compounds represented by general formula (ii-1) and general formula (ii-2).

The compound represented by general formula (ii) is preferably a compound represented by general formula (ii-1) below:

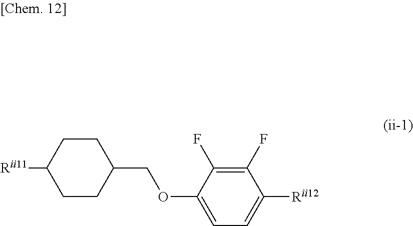

(In the formula, Rⁱⁱ¹¹ and Rⁱⁱ¹² each independently represent an alkyl group having 1 to 8 carbon atoms, an alkenyl group having 2 to 8 carbon atoms, or an alkoxy group having 1 to 8 carbon atoms.)

Rⁱⁱ¹¹ preferably represents as alkyl group haying 1 to 5 carbon atoms or an alkenyl group having 2 to 5 carbon atoms, and preferably represents an ethyl group, a propyl group, or a butyl group. Rⁱⁱ¹¹ preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-1) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When a compound represented by general formula (ii-1) and a compound represented by general formula (i) are used in combination, the viscosity can be significantly decreased, and a liquid crystal composition suitable for high-speed response can be prepared.

When improving Δε is important, the content is preferably set relatively high; when low-temperature solubility is important, it is highly effective to set the content relatively high; and when T_{NT} is important, it is highly effective to set the content relatively high. In order to improve drop marks and image-sticking properties, the range of the content is preferably set intermediate.

The preferable lower limit of the content of the compound represented by formula (ii-1) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii-1) is preferably a compound selected from the group consisting of compounds represented by formula (ii-1.1) to formula (ii-1.12), is more preferably compounds represented by formula (ii-1.1) to formula (ii-1.5), and is yet more preferably compounds represented by formula (ii-1.1) and formula (ii-1.3).

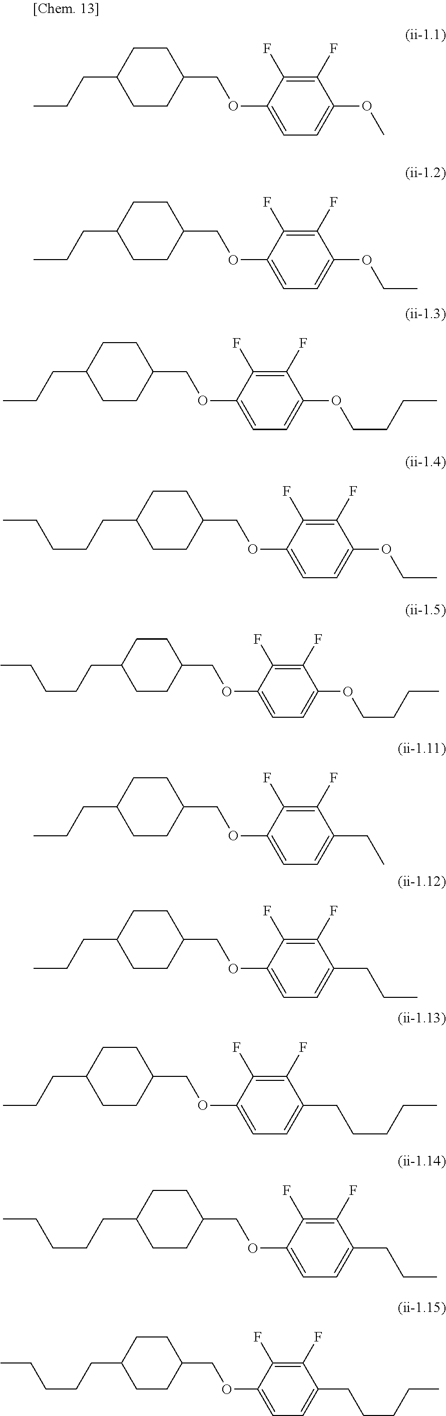

The compounds represented by formula (ii-1.1) and formula (ii-1.2) can be used alone or in combination, and the preferable lower limit of the content of these compounds used alone or in combination relative to the total of the composition of the present invention is 5%, 8%, 10%, 12%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii) is preferably a compound represented by general formula (ii-2) below:

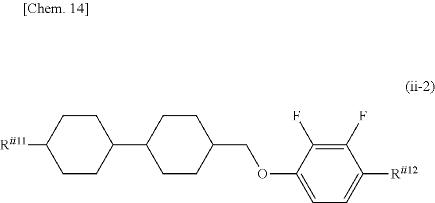

(In the formula, Rⁱⁱ¹¹ and Rⁱⁱ¹² each independently represent an alkyl group having 1 to 8 carbon atoms, an alkenyl group having 2 to 8 carbon atoms, or an: alkoxy group having 1 to 8 carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-2) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When a compound represented by general formula (ii-2) and a compound represented by general formula (i) are used in combination, the viscosity can be significantly decreased, and a liquid crystal composition suitable for high-speed response can be prepared.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The preferable lower limit of the content of the compound represented by formula (ii-2) relative to: the total of the composition of the present invention is 2%, 5%, 10%, 12%, 13%, 15%, 16%, 17%, 18%, or 19%. The preferable upper limit of the content relative to the total of the composition of the present invention is 35%, 30%, 28%, 25%, 23%, 20%, or 19%.

The compound represented by general formula (ii-2) is preferably a compound selected from the group consisting of compounds represented by formulae (ii-2.1) to (ii-2.25), is more preferably compounds represented by formula (ii-2.1) to (ii-2.15), and is yet more preferably compounds represented by formula (ii-2.1) and formula (ii-2.4).

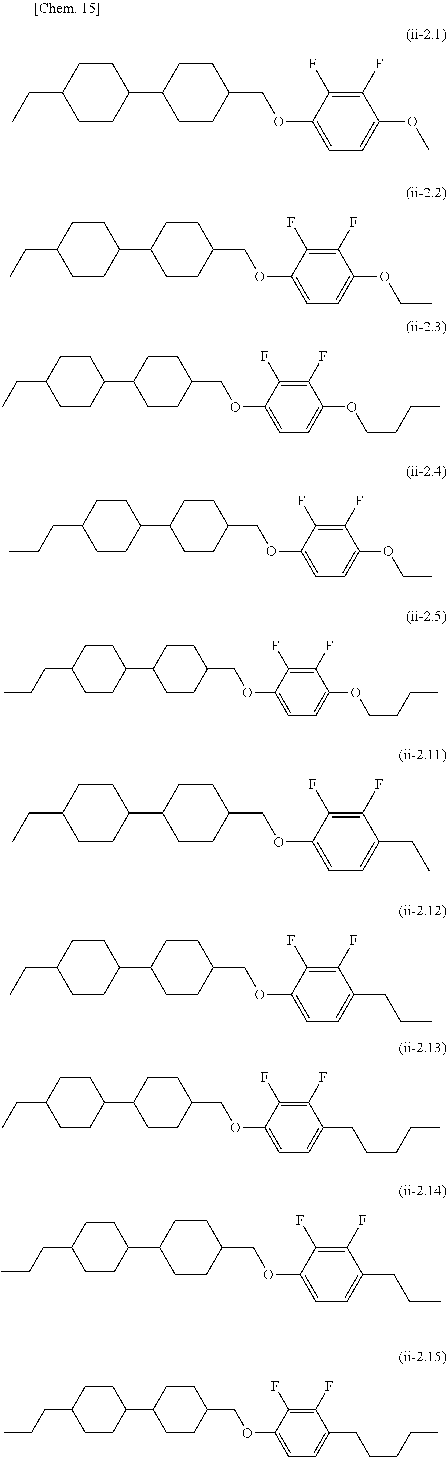

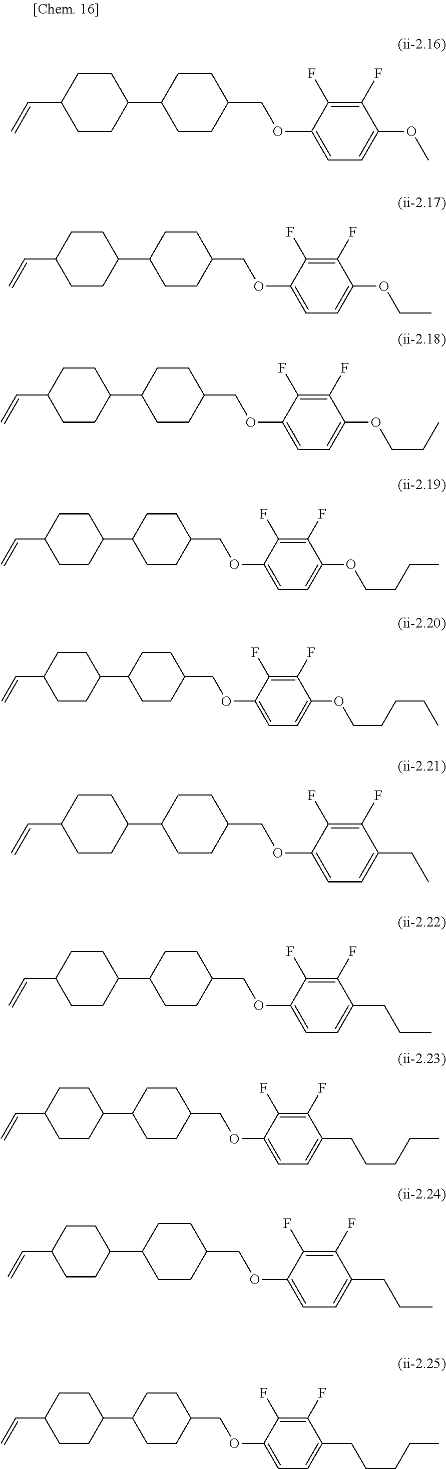

The compounds represented by formula (ii-2.2) and formula (ii-2.4) can be used alone or in combination, and the preferable lower limit of the content of these compounds used alone or in combination relative to the total of the composition of the present invention is 5%, 8%, 10%, 11%, 12%, 13%, or 15%. The preferable upper limit of the content relative to the total of the composition of the present invention is 35%, 30%, 28%, 25%, 23%, 20%, 19%, 18%, 15%, or 13%.

The compound represented by general formula (ii) is preferably a compound represented by general formula (ii-3) below:

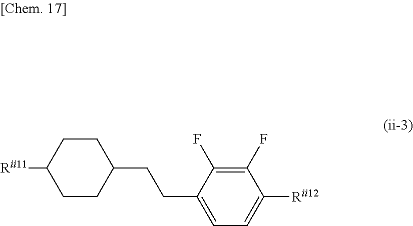

(In the formula, Rⁱⁱ¹¹ and Rⁱⁱ¹² each independently represent an alkyl group having 1 to 8 carbon atoms, an alkenyl group having 2 to 8 carbon atoms, or an: alkoxy group having 1 to 8 carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-3) can be used alone, or two or more compounds can be used in combination. The number of compounds that can be used in combination is not particularly limited, and the compounds are appropriately used in combination, depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The compound represented by general formula (ii-3) is preferably a compound selected from the group consisting of compounds represented by formulae (ii-3.1) to fix (ii-3.25), is more preferably compounds represented by formula (ii-3.1) to (ii-3.15), and is yet more preferably compounds represented by formula (ii-3.1) and formula (ii-3.4).

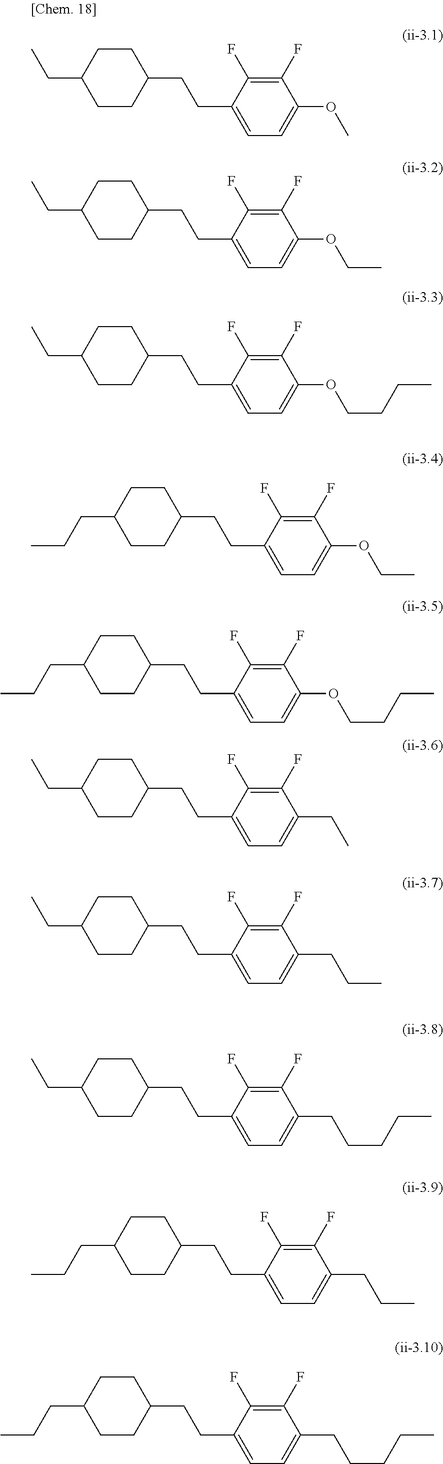

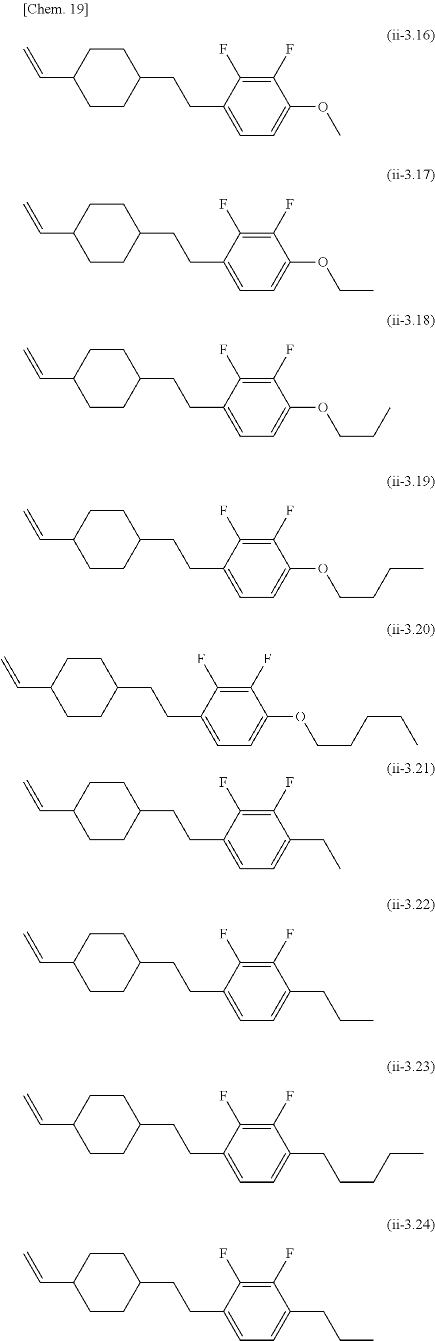

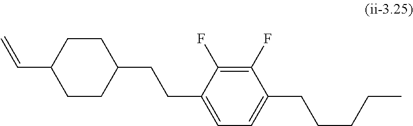 [SMILES: C=CC1CCC(CCc2ccc(CCCCC)c(F)c2F)CC1]

The preferable lower limit of the content of the compound represented by formula (ii-3) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii) is preferably a compound represented by general formula (ii-4) below:

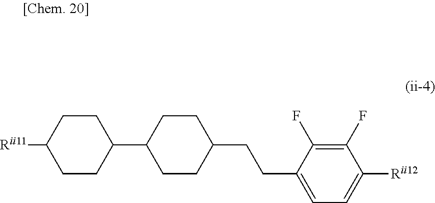

(In the formula, Rⁱⁱ¹¹ and Rⁱⁱ¹² each independently represent an alkyl group having 1 to 8 carbon atoms, an alkenyl group having 2 to 8 carbon atoms, or an alkoxy group having 1 to 8carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-4) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The compound represented by general formula (ii-4) is preferably a compound selected from the group consisting of compounds represented by formulae (ii-4.1) to (ii-4.15), is more preferably compounds represented by formula (ii-4.1) to (ii-4.15), and is yet more preferably compounds represented by formula (ii-4.1) and formula (ii-4.4).

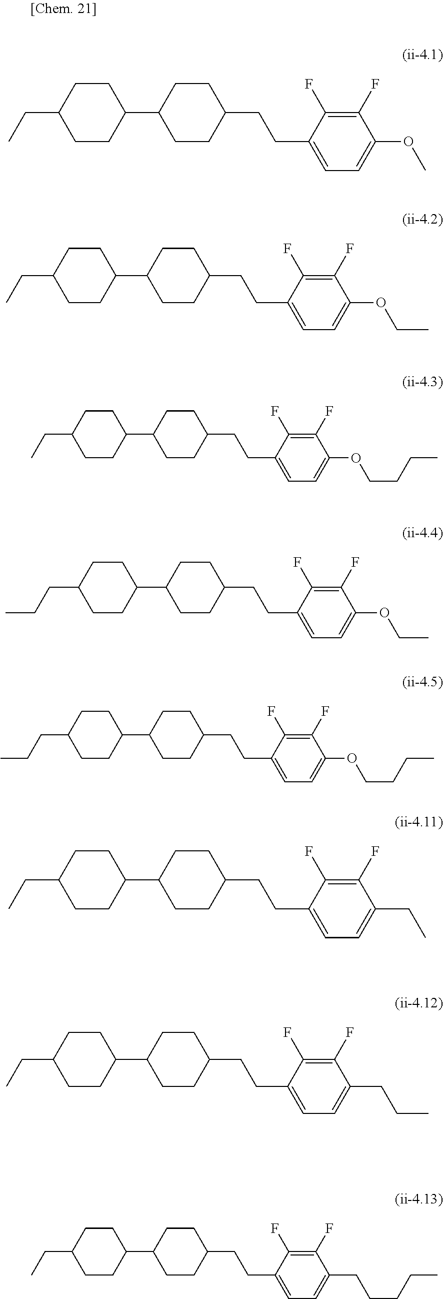

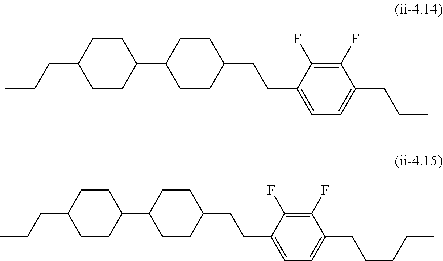

The preferable lower limit of the content of the compound represented by formula (ii-4) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii) is preferably a compound represented by general formula (ii-5) below:

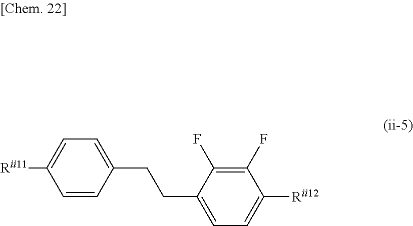

(In the formula, Rⁱⁱ¹¹ and Rⁱⁱ¹² each independently represent an alkyl group having 1 to 8 carbon atoms, an alkenyl group having 2 to 8 carbon atoms, or an: aikoxy group having 1 to 8 carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or at butoxy group.

The compounds represented by general formula (ii-5) can be used alone, or two or more compounds can be used in combination. The number of compounds that can be used in combination is not particularly limited, and the compounds are appropriately used in combination, depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The compound represented by general formula (ii-5) is preferably a compound selected from the group consisting of compounds represented by formulae (ii-5.1) to (ii-5.10), is more preferably compounds represented by formula (ii-5.1) to (ii-5.5), and is yet more preferably compounds represented by formula (ii-5.1) and formula (ii-5.4).

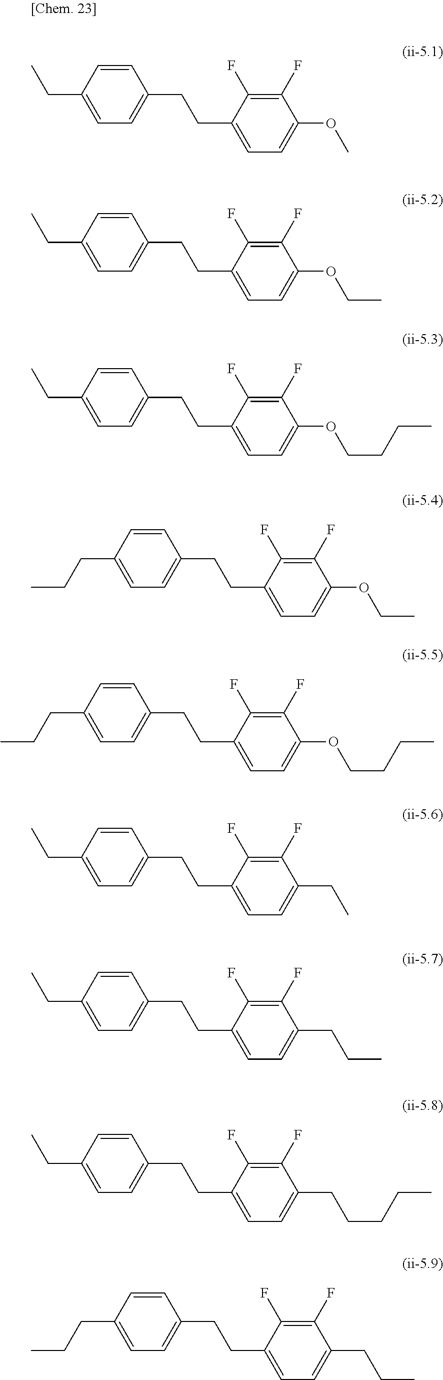

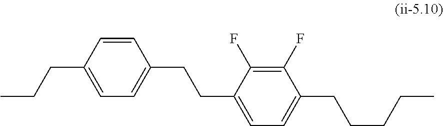 [SMILES: CCCCCc1ccc(CCc2ccc(CCC)cc2)c(F)c1F]

The preferable lower limit of the content of the compound represented by formula (ii-5) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii) is preferably a compound represented by general formula (ii-6) below:

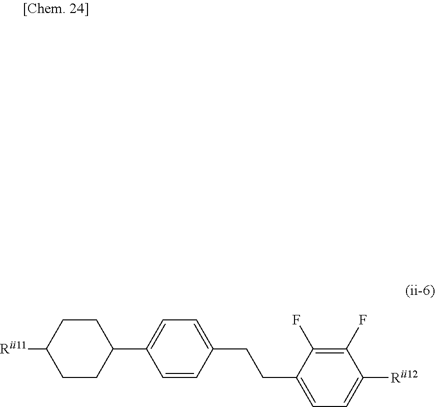

(In the formula, Rⁱⁱ¹¹ and Rⁱⁱ¹² each independently represent an alkyl group having 1 to 8 carbon atoms, an alkenyl group having 2 to 8 carbon atoms, or an alkoxy group having 1 to 8 carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-6) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The preferable lower limit of the content of the compound represented by formula (ii-6) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii) is preferably a compound represented by general formula (ii-7) below:

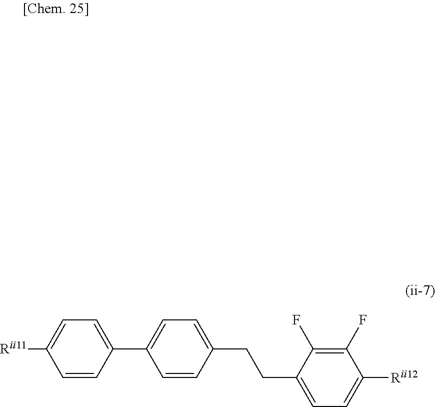

(In the formula, Rⁱⁱ¹¹ and Rⁱⁱ¹² each independently represent an alkyl group having 1 to 8 carbon atoms, an alkenyl group having 2 to 8 carbon atoms, or an alkoxy group having 1 to 8 carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-7) can be used alone, or two or more compounds can be used in combination. The number of compounds that can be used in combination, is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The compound represented by general formula (ii-7) is preferably a compound selected from the group consisting of compounds represented by formulae (ii-7.1) to (ii-7.10), is more preferably compounds represented by formula (ii-7.1) to (ii-7.5), and is yet more preferably compounds represented by formula (ii-7.2) and formula (ii-7.4).

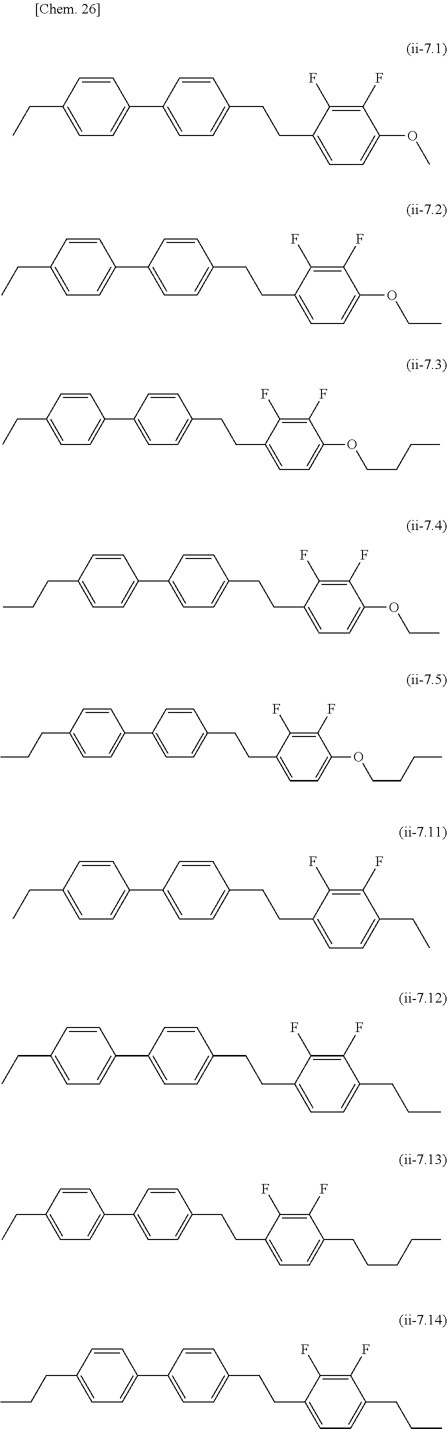

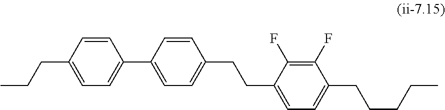 [SMILES: CCCCCc1ccc(CCc2ccc(-c3ccc(CCC)cc3)cc2)c(F)c1F]

The preferable lower limit of the content of the compound represented by formula (ii-7) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii) is preferably a compound represented by general formula (ii-8) below:

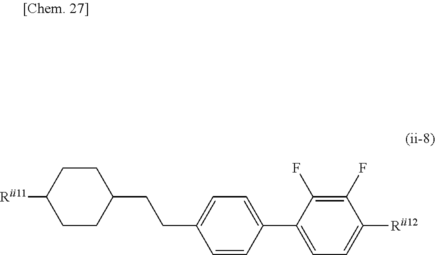

(In the formula, Rⁱⁱ¹¹ and Rⁱⁱ¹² each independently represent an alkyl group having 1 to 8 carbon atoms, an alkenyl group having 2 to 8 carbon atoms, or an alkoxy group having 1 to 8 carbon atoms.)

Rⁱⁱ¹¹ preferabiy represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-8) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The preferable lower limit of the content of the compound represented by formula (ii-8) relative to the total of the composition of the present invention is 5%, 10%, 13%, 15%, 17%, or 20%. The preferable upper limit of the content relative to the total of the composition of the present invention is 35%, 30%, 28%, 25%, 23%, 20%, 18%, 15%, or 13%.

The compound represented by general formula (ii-9) is the following compound:

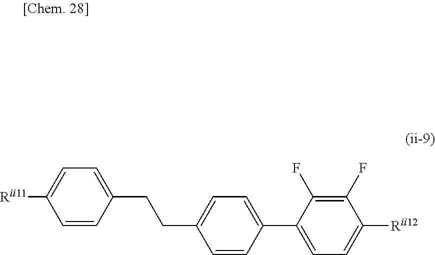

(In the formula, Rⁱⁱ¹¹ and Rⁱⁱ¹² each independently represent an alkyl group having 1 to 8 carbon atoms:, an alkenyl group, having 2 to 8 carbon atoms, or an alkoxy group having 1 to 8 carbon atoms.)

Rⁱⁱ¹¹ preferably represents an alkyl group having 1 to 5 carbon atoms or an alkenyl group having 2 to 5 carbon atoms, and preferably represents an ethyl group, a propyl group, or a butyl group. Rⁱⁱ¹² preferably represents an alkyl group having 1 to 5 carbon atoms, an alkenyl group having 4 or 5 carbon atoms, or an alkoxy group having 1 to 4 carbon atoms, and preferably represents an ethoxy group, a propoxy group, or a butoxy group.

The compounds represented by general formula (ii-9) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When a compound represented by general formula (i) and a compound represented by general formula (ii-9) are used in combination, the compound represented by general formula (i) having an effect of decreasing the viscosity and the compound represented by general formula (ii-9) improving the elastic constant (K33) have synergetic effects on decreasing the γ1 of the liquid crystal composition as a whole.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The compound represented by general formula (ii-9) is preferably a compound selected from the group consisting of compounds represented by formulae (ii-9.1) to (ii-9.10), is more preferably compounds represented by formula (ii-9.1) to (ii-9.5), and is yet more preferably compounds represented by formula (ii-9.1) and forum la (ii-9.4).

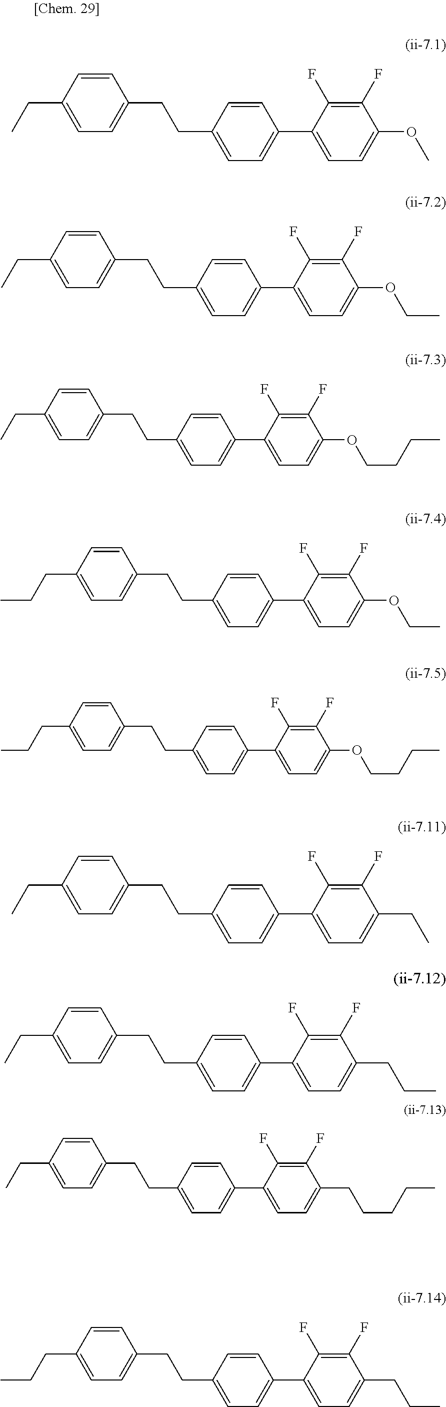

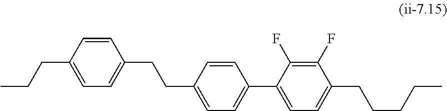 [SMILES: CCCCCc1ccc(-c2ccc(CCc3ccc(CCC)cc3)cc2)c(F)c1F]

The preferable lower limit of the content of the compound represented by formula (ii-9) relative to the total of the composition of the present invention is 1%, 2%, 3%, 4%, 5%, 6%, 10%, 13%, 15%, or 18%. The preferable upper limit of the content relative to the total of the composition of the present invention is 35%, 30%, 28%, 25%, 23%, 20%, 18%, 15%, or 13%.

The compound represented by general formula (ii-10) is the following compound:

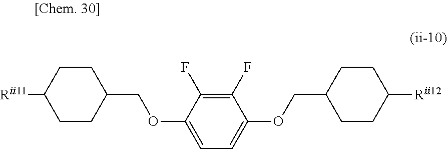

(In the formula, Rⁱⁱ¹¹ and Rⁱⁱ¹² each independently represent an alkyl group having 1 to 8 carbon atoms, an alkenyl group having 2 to 8 carbon atoms, or an alkoxy group having 1 to 8 carbon atoms.)

The compound represented by general formula (ii-11) is the following compound:

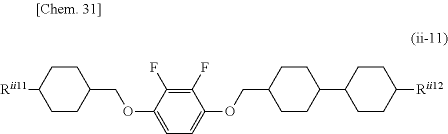

(In the formula, Rⁱⁱ¹¹ and Rⁱⁱ¹² each independently represent as alkyl group having 1 to 8 carbon atoms, an alkenyl group having 2 to 8 carbon atoms, or an alkoxy group having 1 to 8 carbon atoms.)

The liquid crystal composition of the present invention may contain, in addition to the compounds represented by general formula (i) and general formula (ii), which are essential components, one or two or more compounds selected from the group consisting of compounds represented by general formula (L), general formula (N-1), general formula (N-2), and general formula (N-3).

The liquid crystal composition of the present invention preferably contains, as the compound that is substantially dielectrically neutral (the value of Δε is −2 to 2), one or two or more compounds selected from the group consisting of compounds represented by general formula (L). The compound represented by general formula (L) preferably corresponds to a compound substantially dielectrically neutral (the value of Δε is −2 to 2).

As the compound that is substantially dielectrically neutral (the value of Δε is −2 to 2), which is an optional component of the liquid crystal composition of the present-invention, a compound represented by general formula (L) is preferable:

[Chem. 32]

R^{L1}-A^{L1}-Z^{L1}A^{L2}-Z^{L2}ₙ_{^{L1}}A^{L3}-R^{L2} (L)

(In the formula, R^{L1} and R^{L2} each independently represent an alkyl group having 1 to 8 carbon atoms, one —CH₂— or two or more non-adjacent —CH₂— in the alkyl group may each independently be substituted with —CH═C—, —C═C—, —O—, —CO—, —COO—, or OCO—,

n^{L1} represents 0, 1, 2, or 3,

A^{L1}, A^{L2}, and A^{L3} each independently represent a group selected from the group consisting of
(a) a 1,4-cyclohexylene group (one —CH₂— or two or more non-adjacent —CH₂— present in this group may each be substituted with —O—) and
(b) a 1,4-phenylene group (one —CH═ or two or more non-adjacent —CH═ present in this group may each be substituted with —N═)
(c) (c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═ present in the naphthalene-2,6-diyl group or the 1,2,3,4-tetrahydronaphthalene-2,6-diyl group may each be substituted with —N═),
where the group (a), the group (b), and the group (c) may each independently be substituted with a cyano group, a fluorine atom, or a chlorine atom,

Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or C═C—, and

when n^{L1} represents 2 or 3 and multiple A^{L2} are present, they may be the same or different, and when n^{L1} represents 2 or 3 and multiple Z^{L3} are present, they may be the same or different; however, compounds represented by general formula (i), general formula (ii), general formula (N-1), general formula (N-2), and general formula (N-3) are excluded.)

The compounds represented by general formula (L) can be used alone or in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, one. In other embodiments of the present invention, the number is 2, 3, 4, 5, 6, 7, 8, 9, 10, or more.

In the composition of the present invention, the content of the compound represented by general formula (L) must be adjusted according to the desired performance, such as low-temperature solubility, transition temperature, electrically reliability, birefringence, process compatibility, drop marks, image-sticking, dielectric anisotropy, etc.

The preferable lower limit of the content of the compound represented by formula (L) relative to the total of the composition of the present invention is 1%, 10%, 20%, 30%, 40%, 50%, 55%, 60%, 65%, 70%, 75%, or 80%. The preferable upper limit of the content is 95%, 85%, 75%, 65%, 55%, 45%, 35%, or 25%.

When the viscosity of the composition of the present invention needs to be maintained low and when a composition having high response speed is necessary, the lower limit, is preferably high and the upper limit is preferably high. When Tni of the composition of the present invention needs to be maintained high and when a composition with excellent temperature stability is necessary, the lower limit is preferably high and the upper limit is preferably high. When it is desirable to increase the dielectric anisotropy to maintain the drive voltage low, the lower limit is preferably low and the upper limit is preferably low.

When reliability is important, R^{L1} and R^{L2} preferably both represent an alkyl group; when decreasing volatility of the compound is important, an alkoxy group is preferable; and when decreasing the viscosity is important, at least one of R^{L1} and R^{L2} preferably represents an alkenyl group.

When the ring structures that R^{L1} and R^{L2} are bonded to are each a phenyl group (aromatic), a linear alkyl group having 1 to 5 carbon atoms, a linear alkoxy group having 1 to 4 carbon atoms, and an alkenyl group having 4 or 5 carbon atoms are preferable. When the ring structures they are bonded to are saturated ring structures, such as cyclohexane, pyran, or dioxane, a linear alkyl group having 1 to 5 carbon atoms, a linear alkoxy group having 1 to 4 carbon atoms, and a linear alkenyl group having 2 to 5 carbon atoms are preferable. In order to stabilize the nematic phase, the total number of carbon atoms and, if any, oxygen atoms is preferably 5 or less, and a linear structure is preferred.

The alkenyl group is preferably selected from the groups represented by formula (R1) to formula (R5). (In each formula, the dot represents a carbon atom in the ring structure.)

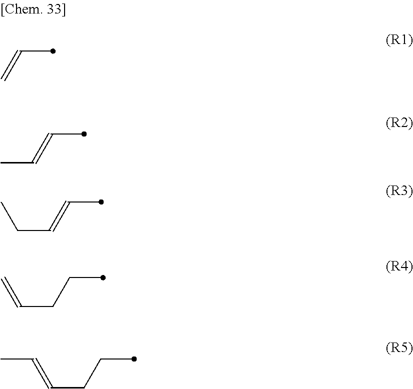

When response speed is important, n^{L1} preferably represents 0; in order to improve the upper limit temperature of the nematic phase, n^{L1} preferably represents 2 or 3; and in order to strike a balance between them, n^{L1} preferably represents 1. In order to satisfy properties required for the composition, compounds with different values are preferably used in combination.

When increasing Δε is desirable, A^{L1}, A^{L2}, and A^{L3} are preferably aromatic. In order to improve the response speed, A^{L1}, A^{L2}, and A^{L3} are preferably aliphatic. A^{L1}, A^{L2}, and A^{L3} preferably each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and more preferably represent the following structure:

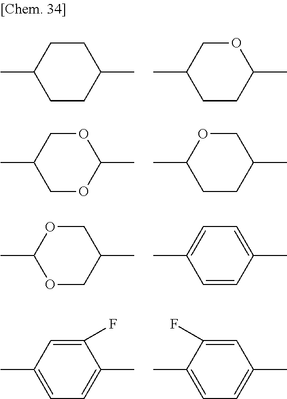

More preferably, A^{L1}, A^{L2}, and A^{L3} each represent a trans-1, 4-cyclohexylene group or a 1,4-phenylene group.

When response speed is important, Z^{L1} and Z^{L2} preferably each represent a single bond.

The compound represented by general formula (L) is preferably a compound selected from the group consisting of compounds represented by general formulae (L-1) to (L-7).

The compound represented by general formula (L-1) is the following compound:

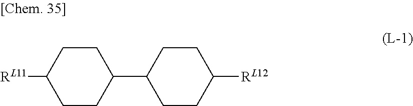

(In the formulae, R^{L11} and R^{L12} are each independently the same as R^{L1} and R^{L2} in general formula (L).)

R^{L11} and R^{L12} preferably each represent a linear alkyl group having 1 to 5 carbon atoms, a linear alkoxy group having 1 to 4 carbon atoms, or a linear alkenyl group having 2 to 5 carbon atoms.

The compounds represented by general formula (L-1) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

The preferable lower limit of the content relative to the total of the composition of the present invention is 1%, 2%, 3%, 5%, 7%, 10%, 15%, 20%, 25%, 30%, 35%, 40%, 45%, 50%, or 55%. The preferable upper limit of the content relative to the total of the composition of the present invention is 95%, 90%, 85%, 80%, 75%, 70%, 65%, 60%, 55%, 50%, 45%, 40%, 35%, 30%, or 25%.

When the viscosity of the composition of the present invention needs to be maintained low and when a composition having high response speed is necessary, the lower limit is preferably high and the upper limit is preferably high. When Tni of the composition of the present invention needs to be maintained high and when a composition with excellent temperature stability is necessary, the lower limit is preferably intermediate and the upper limit is preferably intermediate. When it is desirable to increase the dielectric anisotropy to maintain the drive voltage low, the lower limit is preferably low and the upper limit is preferably low.

The compound represented by general formula (L-1) is preferably a compound selected from the group consisting of compounds represented by general formulae (L-1-1).

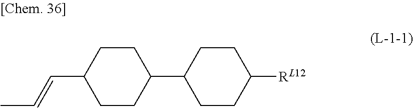

(In the formula, R^{L12} is the same as in general formula (L-1).)

The compound represented by general formula (L-1-1) is preferably a compound selected from the group consisting of compounds represented by formulae (L-1-1.1) to (L-1-1.3), is more preferably compounds represented by formula (L-1-1.2) or (L-1-1.3), and is yet more preferably compounds represented by formula (L-1-1.3).

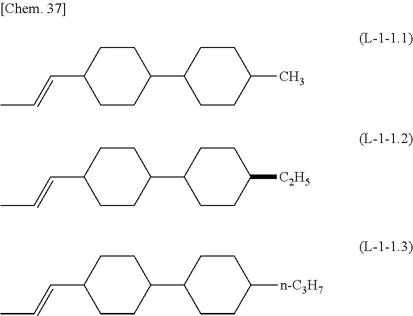

The preferable lover limit of the content of the compound represented by formula (L-1-1.3) relative to the total of the composition of the present invention is 1%, 2%, 3%, 5%, 7%, or 10%. The preferable upper limit of the content relative to the total of the composition of the present invention is 20%, 15%, 13%, 10%, 8%, 7%, 6%, 5%, or 3%.

The compound represented by general formula (L-1) is preferably a compound selected from the group consisting of compounds represented by general formulae (L-1-2).

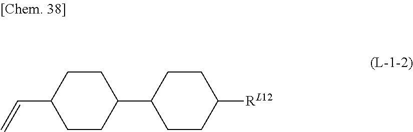

(In the formula, R^{L12} is the same as in general formula (L-1).)

The preferable lower limit of the content of the compound represented by formula (L-1-2) relative to the total of the composition of the present invention is 1%, 5%, 10%, 15%, 17%, 20%, 23%, 25%, 27%, 30%, and 35%. The preferable upper limit of the content relative to the total of the composition of the present invention is 60%, 55%, 50%, 45%, 42%, 40%, 38%, 35%, 33%, or 30%.

The compound represented by general formula (L-1-2) is. preferably a compound selected frost the group consisting of compounds represented by formula (L-1-2.1) to formula (i-1-2.4), and is more preferably compounds represented by formula (L-1-2.2) to formula (L-1-2.4). In particular, the compound represented by formula (L-1-2.2) is preferable since it particularly improves the response speed of the composition of the present invention. When high Tni is desirable rather than the response speed, the compound represented by formula (L-1-2.3) or formula (L-1-2.4) is preferably used. The content of the compounds represented by formula (L-1-2.3) and formula (L-1-2.4) is preferably less than 30% in order to improve low-temperature solubility.

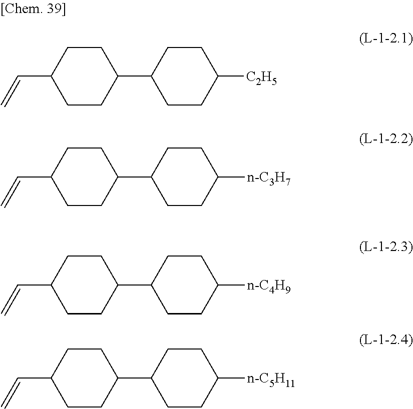

The preferable lower limit of the content of the compound represented by formula (L-1-2.2) relative to the total of the composition of the present invention is 10%, 15%, 18%, 20%, 23%, 25%, 27%, 30%, 33%, 35%, 38%, or 40%. The preferable upper limit of the content relative to the total of the composition of the present invention is 60%, 55%, 50%, 45%, 43%, 40%, 38%, 35%, 32%, 30%, 27%, 25%, or 22%.

The preferable lower limit of the total content of the compounds represented by formula (L-1-1.3) and formula (L-1-2.2) relative to the total of the composition of the present invention is 10%, 15%, 20%, 25%, 27%, 30%, 35%, or 40%. The preferable upper limit of the content relative to the total of the composition of the present invention is 60%, 55%, 50%, 45%, 43%, 40%, 38%, 35%, 32%, 30%, 27%, 25%, or 22%.

The compound represented by general formula (L-1) is preferably a compound selected from the group consisting of compounds represented by general formulae (L-1-3).

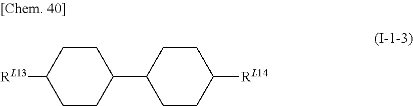

(In the formula, R^{L13} and R^{L14} each independently represent an alkyl group having 1 to 8 carbon atoms or an alkoxy group having 1 to 8 carbon atoms.)

R^{L13} and R^{L14} preferably each represent a linear alkyl group having 1 to 5 carbon atoms, a linear alkoxy group having 1 to 4 carbon atoms, or a linear alkenyl group having 2 to 5 carbon atoms.

The preferable lower limit of the content of the compound represented by formula (L-1-3) relative to the total of the composition of the present invention is 1%, 5%, 10%, 13%, 15%, 17%, 20%, 23%, 25%, or 30%. The preferable upper limit of the content relative to the total of the composition of the present invention is 60%, 55%, 50%, 45%, 40%, 37%, 35%, 33%, 30%, 27%, 25%, 23%, 20%, 17%, 15%, 13%, or 10%.

The compound represented by general formula. (L-1-3) is preferably a compound selected from the group consisting of compounds represented by formula (L-1-3.1) to formula (L-1-3.12), and is more preferably a compound represented by formula (L-1-3.1), formula (L-1-3.3), or formula (L-1-3.4). In particular, the compound represented by formula (L-1-3.1) is preferable since it particularly improves the response speed of the composition of the present invention. When high Tni is desirable rather than the response speed, the compounds represented by formula (L-1-3.3), formula (L-1-3.4), formula (L-1-3.11), and formula (L-1-3.12) are preferably used. The total content of the compounds represented by formula (L-1-3.3), formula (L-1-3.4), formula (L-1-3.11), and formula (L-1-3.12) is preferably less than 20% in order to improve low-temperature solubility.

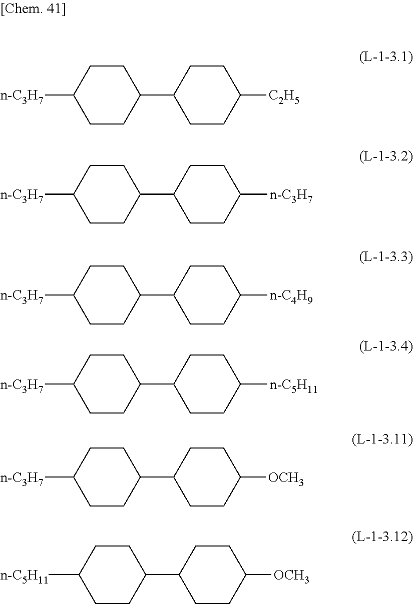

The preferable lover limit of the content of the compound represented by formula (L-1-3.1) relative to the total of the composition of the present invention is 1%, 2%, 3%, 5%, 7%, 10%, 13%, 15%, 18%, or 20%. The preferable upper limit of the content relative to the total of the composition of the present invention is 20%, 17%, 15%, 13%, 10%, 8%, 7% or 6%

The compound represented by general formula (L-1) is preferably a compound selected from the group consisting of compounds represented by general formula (L-1-4) and/or general formula (L-1-5).

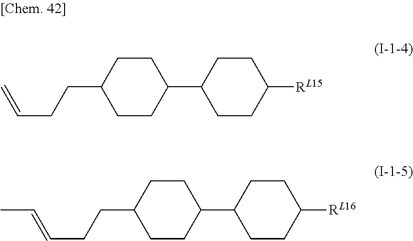

(In the formula, R^{L15} and R^{L16} each independently represent an alkyl group having 1 to 8 carbon atoms or an alkoxy group having 1 to 8 carbon atoms.)

R^{L15} and R^{L16} preferably each represent a linear alkyl group having 1 to 5 carbon atoms, a linear alkoxy group having 1 to 4 carbon atoms, or a linear alkenyl group having 2 to 5 carbon atoms.

The preferable lover limit of the content of the compound represented by formula (L-1-4) relative to the total of the composition of the present invention is 1%, 5%, 10%, 13%, 15%, 17%, or 20%. The preferable upper limit of the content relative to the total of the composition of the present invention is 25%, 23%, 20%, 17%, 15%, 13%, or 10%.

The preferable lower limit of the content of the compound represented by formula (L-1-5) relative to the total of the composition of the present invention is 1%, 5%, 10%, 13%, 15%, 17%, or 20%. The preferable upper limit of the content relative to the total of the composition of the present invention is 25%, 23%, 20%, 17%, 15%, 13%, or 10%.

The compounds represented by general formula (L-1-4) and (L-1-5) are preferably compound's selected from the group consisting of compounds represented by formula (L-1-4.1) to formula (L-1-5.3), and are preferably a compound represented by formula (L-1-4.2) or (L-1-5.2).

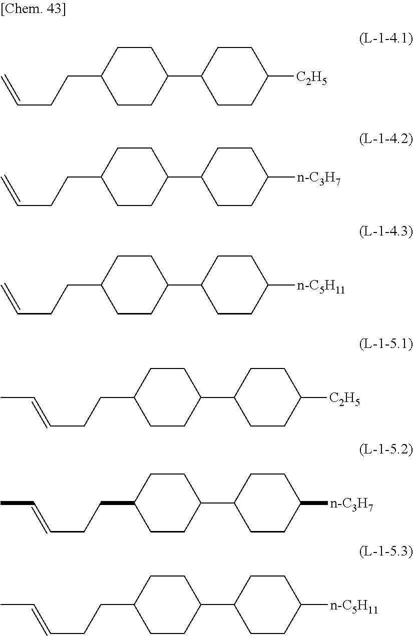

The preferable lower limit of the content of the compound represented by formula (L-1-4.2) relative to the total of the composition of the present invention is 1%, 2%, 3%, 5%, 7%, 10%, 13%, 15%, 18%, or 20%. The preferable upper limit of the content relative to the total of the composition of the present invention is 20%, 17%, 15%, 13%, 10%, 8%, 7%, or 6%,

Two or more compounds selected from compounds represented by formula (L-1-1.3), formula (L-1-2.2), formula (L-1-3.1), formula (L-1-3.3), formula (L-1-3.4), formula (L-1-3.11), and formula (L-1-3.12) are preferably used in combination; two or more compounds selected from compounds represented by formula (L-1-1.3), formula (L-1-2.2), formula (L-1-3.1), formula (L-1-3.3), formula (L-1-3.4), and formula (L-1-4.2) are preferably used in combination; the preferable lower limit of the total content of these compounds relative to the total of the composition of the present invention is 1% 2%, 3%, 5%, 7%, 10%, 13%, 15%, 18%, 20%, 23%, 25%, 27%, 30%, 33%, or 35%; and the upper limit relative to the total of the composition of the present invention is 80%, 70%, 60%, 50%, 45%, 40%, 37%, 35%, 33%, 30%, 28%, 25%, 23%, or 20%. When the reliability of the composition is important, two or more compounds selected from compounds represented by formula (L-1-3.1), formula (L-1-3.3), and formula (L-1-3.4) are preferably used in combination; and when the response speed of the composition is important, two or more compounds selected from compounds represented by formula (L-1-1.3) and formula (L-1-2.2) are preferably used in combination.

The compound represented by general formula (L-2) is the following compound:

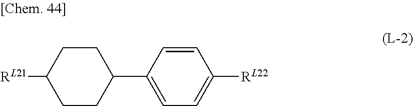

(In the formulae, R^{L21} and R^{L22} are each independently the same as R^{L1} and R^{L2} in general formula (L).)

R^{L21} preferably represents an alkyl group having 1 to 5 carbon atoms or an alkenyl group having 2 to 5 carbon atoms, and R^{L22} preferably represents an alkyl group having 1 to 5 carbon atoms, an alkenyl group having 4 or 5 carbon atoms, or an alkoxy group having 1 to 4 carbon atoms.

The compounds represented by general formula (L-1) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When low-temperature solubility is important, it is highly effective; to set the content relatively high; and, conversely, when response speed is important, it is highly effective to set the content relatively low. In order to improve drop marks and image-sticking properties, the range of the content is preferably set intermediate.

The preferable lower limit of the content of the compound represented by formula (L-2) relative to the total of the composition of the present invention is 1%, 2%, 3%, 5%, 7%, or 10%. The preferable upper limit of the content relative to the total of the composition of the present invention is 20%, 15%, 13%, 10%, 8%, 7%, 6%, 5%, or 3%.

The compound represented by general formula (L-2) is preferably a compound selected from the group consisting of compounds represented by formula (L-2.1) to formula (L-2.6), and is more preferably compounds represented by formula (L-2.1), formula (L-2.3), formula (L-2.4), and formula (L-2.6).

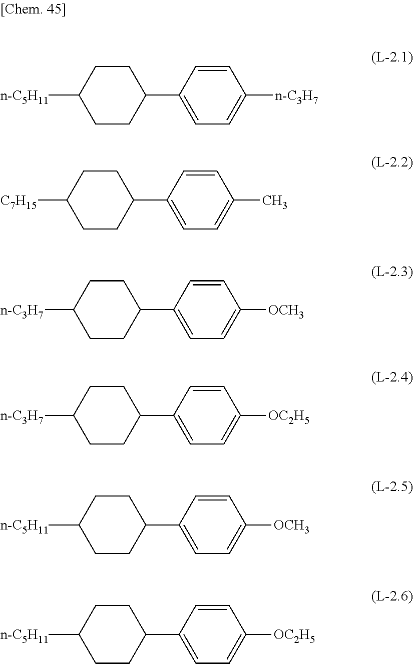

The compound represented by general formula (L-3) is the following compound:

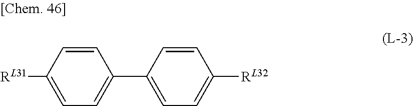

(In the formula, R^{L31} and R^{L32} are each independently the same as R^{L1} and R^{L2} in general formula (L).)

R^{L31} and R^{L32} each independently represent an alkyl group having 1 to 5 carbon atoms, an alkenyl group having 4 or 5 carbon atoms, or an alkoxy group having 1 to 4 carbon atoms.

The compounds represented by general formula (L-3) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

The preferable lower limit of the content of the compound represented by formula (L-3) relative to the total of the composition of the present invention is 1%, 2%, 3%, 5%, 7%, or 10%. The preferable upper limit of the content relative to the total of the composition of the present invention is 20%, 15%, 13%, 10%, 8%, 7%, 6%, 5%, or 3%.

In order to obtain high birefringence, it is highly effective to set the content relatively high; and, conversely, when high Tni is important, it is highly effective to set the content relatively low. In order to improve drop marks and image-sticking properties, the range of the content is preferably set intermediate.

The compound represented by general formula (L-3) is preferably a compound selected from the group consisting of compounds represented by formula (L-3.1) to formula (L-3.4), and is more preferably compounds represented by formulate (L-3.2) to (L-3.7).

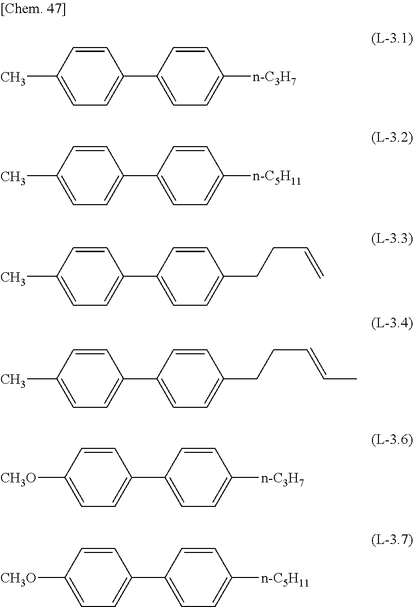

The compound represented by general formula (L-4) is the following compound:

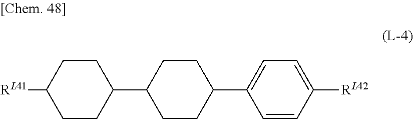

(In the formula, R^{L41} and R^{L42} are each independently the same as R^{L1} and R^{L2} in general formula (L).)

R^{L41} preferably represents an alkyl group having 1 to 5 carbon atoms or an alkenyl group having 2 to 5 carbon atoms, and R^{L42} preferably represents an alkyl group having 1 to 5 carbon atoms, an alkenyl group having 4 or 5 carbon atoms, or an alkoxy group having 1 to 4 carbon atoms.

The compounds represented by general formula (L-4) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

In the composition of the present invention, the content of the compound represented by general formula (L-4) must be adjusted according to the desired performance, such as low-temperature solubility, transition temperature, electrically reliability, birefringence, process compatibility, drop marks, image-sticking, dielectric anisotropy, etc.

The preferable lower limit of the content of the compound represented by formula (L-4) relative to the total of the composition of the present invention is 1%, 2%, 3%, 5%, 7%, 10%, 14%, 16%, 20%, 23%, 26%, 30%, 35%, or 40%. The preferable upper limit of the content, of the compound represented by formula (L-4) relative to the total of the composition of the present invention is 50%, 40%, 35%, 30%, 20%, 15%, 10%, or 5%.

The compound represented by general formula (L-4) is preferably a compound selected from the group consisting of compounds represented by, for example, formulae (L-4.1) to (L-4.3).

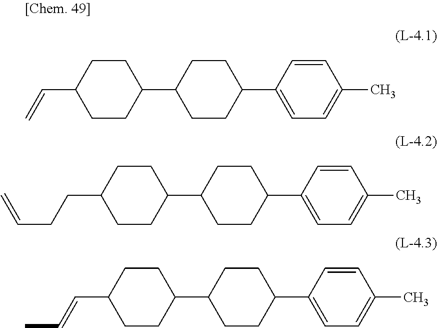

Depending on the desired performance such as low-temperature solubility, transition temperature, electrical reliability, birefringence, etc., a compound represented by formula (L-4.1) may be contained, a compound represented by formula (L-4.2) may be contained, a compound represented by formula (L-4.1) and a compound represented by formula (L-4.2) may both be contained, or all of compounds represented by formula (L-4.1) to (L-4.3) may be contained. The preferable lower limit of the content of the compound represented by formula (L-4.1) or formula (L-4.2) relative to the total of the composition of the present invention is 3%, 5%, 7%, 9%, 11%, 12%, 13%, 18%, or 21%, and the preferable upper limit is 45, 40%, 35%, 30%, 25%, 23%, 20%, 18%, 15%, 13%, 10%, or 8%.

When both compounds represented by formula (L-4.1) and formula (L-4.2) are contained, the preferable lower limit of the content of both compounds relative to the total of the composition of the present invention is 15%, 19%, 24%, or 30%, and the preferable upper limit is 45, 40%, 35%, 30%, 25%, 23%, 20%, 18%, 15%, or 13%.

The compound represented by general formula (L-4) is preferably compounds represented by formula (L-4.4) to formula (L-4.6), and is more preferably compound represented by formulae (L-4.4) or (L-4.5).

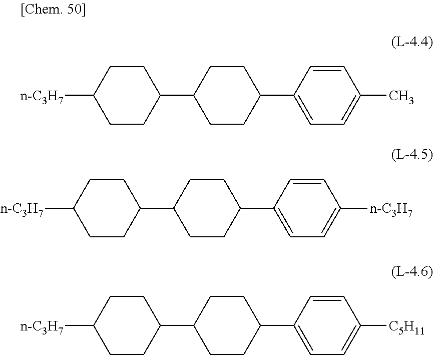

Depending on the desired performance such as low-temperature solubility, transition temperature, electrical reliability, birefringence, etc., a compound represented by formula (L-4.4) may be contained, a compound represented by formula (L-4.5) may be contained, or a compound represented by formula (L-4.4) and a compound represented by formula (L-4.5) may both be contained.

The preferable lower limit of the content of the compound represented by formula (L-4.4) or formula (L-4.5) relative to the total of the composition of the present invention is 3%, 5%, 7%, 9%, 11%, 12%, 13%, 18%, or 21%. The preferable upper limit is 45, 40%, 35%, 30%, 25%, 23%, 20%, 18%, 15%, 13%, 10%, or 8%.

When both compounds represented by formula (L-4.4) and formula (L-4.5) are contained, the preferable lower limit of the content of both compounds relative to the total of the composition of the present invention is 15%, 19%, 24%, or 30%, and the preferable upper limit is 45, 40%, 35%, 30%, 25%, 23%, 20%, 1.8%, 15%, or 13%.

The compound represented by general formula (L-4) is preferably compounds represented by formula (L-4.7) to formula (L-4.10), and is more preferably a compound represented by formula (L-4.9).

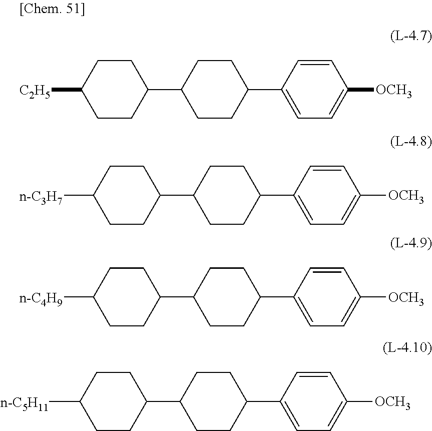

The compound represented by general formula (L-5) is the following compound:

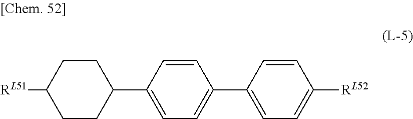

(In the formula, R^{L51} and R^{L52} are each independently the same as R^{L1} and R^{L2} in general formula (L).)

R^{L51} preferably represents an alkyl group having 1 to 5 carbon atoms or an alkenyl group having 2 to 5 carbon atoms, and R^{L52} preferably represents an alkyl group having 1 to 5 carbon atoms, an alkenyl group having 4 or 5 carbon atoms, or an alkoxy group having 1 to 4 carbon atoms.

The compounds represented by general formula (L-5) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

In the composition of the present invention, the content of the compound represented by general formula (L-5) must be adjusted according to the desired performance, such as low-temperature solubility, transition temperature, electrically reliability, birefringence, process compatibility, drop marks, image-sticking, dielectric anisotropy, etc.

The preferable lower limit of the content of the compound represented by formula (L-5) relative to the total of the: composition of the present, invention is 1%, 2%, 3%, 5%, 7%, 10%, 14%, 16%, 20%, 23%, 26%, 30%, 35%, or 40%, The preferable upper limit of the content of the compound represented by formula (L-5) relative to the total of the composition of the present invention is 50%, 40%, 35%, 30%, 20%, 15%, 10%, 5%, or 3%.

The compound represented by general formula (L-5) is preferably a compounds represented by formula (L-5.I) or formula (L-5.2), and is more preferably a compound represented by formula (L-5,1). The preferable lower limit of the content of these compounds relative to the total of the composition of the present invention is 1%, 2%, 3%, 5%, or 7%. The preferable upper limit of the contents of these compounds is 20%, 15%, 13%, 10%, or 9%.

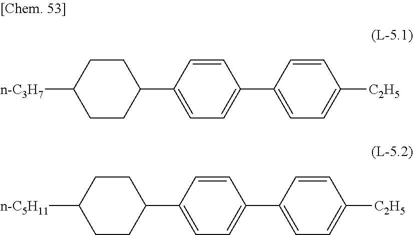

The compound represented by general formula (L-5) is preferably compounds represented by formulae (L-5.3) and (L-5.4). The preferable lower limit of the content of these compounds relative to the total of the composition of the present invention is 1%, 2%, 3%, 5%, or 7%. The preferable upper limit of the content of these compounds is 20%, 15%, 13%, 10%, or 9%.

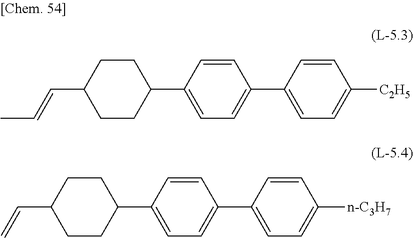

The compound represented by general formula (L-5) is preferably a compound selected from the group consisting of compounds represented by formula (L-5.5) to formula (L-5.7), and is more preferably a compound represented by formula (L-5.7). The preferable lower limit of the content of these compounds relative to the total of the composition of the present, invention is 1%, 2%, 3%, 5%, or 7%. The preferable upper limit of the contents of these compounds is 20%, 15%, 13%, 10%, or 9%.

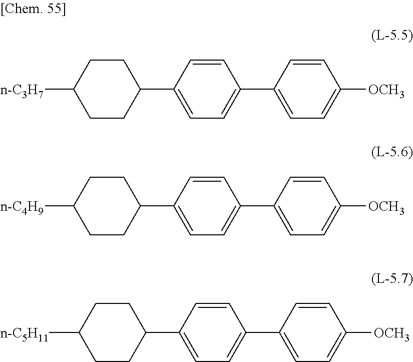

The compound represented by general formula (L-6) is the following compound:

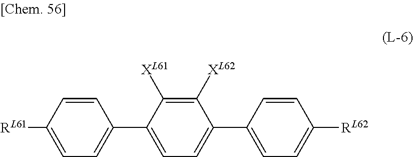

(In the formula, R^{L61} and R^{L62} are each independently the same as R^{L1} and R^{L2} in general formula (L), and X^{L61} and X^{L62} each independently represent a hydrogen atom, or a fluorine atom.)

R^{L61} and R^{L62} each independently represent an alkyl group having 1 to 5 carbon atoms or an alkenyl group having 2 to 5 carbon atoms, and one of X^{L61} and X^{L62} preferably represents a fluorine atom and the other preferably represents a hydrogen atom.

The compounds represented by general formula (L-6) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

The preferable lower limit of the content of the compound represented by formula (L-6) relative to the total of the composition of the present invention is 1%, 2%, 3%, 5%, 7%, 10%, 14%, 16%, 20%, 23%, 26%, 30%, 35%, or 40%. The preferable upper limit of the content of the compound represented by formula (L-6) relative to the total of the composition of the present invention is 50%, 40%, 35%, 30%, 20%, 15%, 10%, or 5%. When increasing Δn is important, the content is preferably high, and when precipitation at low temperature is important, the content is preferably low.

The compound represented by general formula (L-6) is preferably compounds represented by formulae (L-6.1) to (L-6.9).

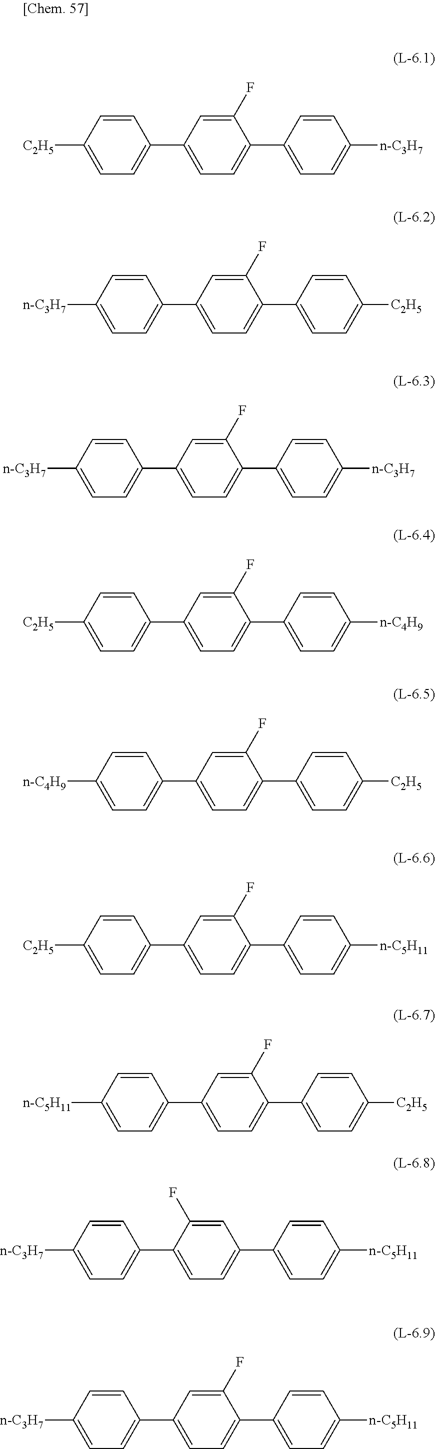

The number of compounds that can be used in combination is not particularly limited; however, preferably, 1 to 3 of these compounds are contained, and more preferably 1 to 4 of these compounds are contained. Since it is effective for solubility to select compounds having wide molecular weight distributions, one compound is preferably selected from those represented by formula (L-6.1) and formula (L-6.2), one compound is preferably selected from those represented by formula (L-6.4) and formula (L-6.5), one compound is preferably selected from those represented by formulae (L-6.6) and (L-6.7), one compound is preferably selected from those represented by formulae (L-6.3) and (L-6.9), and the selected compounds are preferably appropriately combined. Among these, compounds represented by formula (L-6.1), formula (L-6.3), formula, (L-6.4), formula (L-6.6), and formula (L-6.9) are preferably contained.

Furthermore, the compound represented by general formula (L-6) is preferably compounds represented by, for example, formula (L-6.10) to formula (L-6.17), and is more preferably a compound represented by formula (L-6.11) among these.

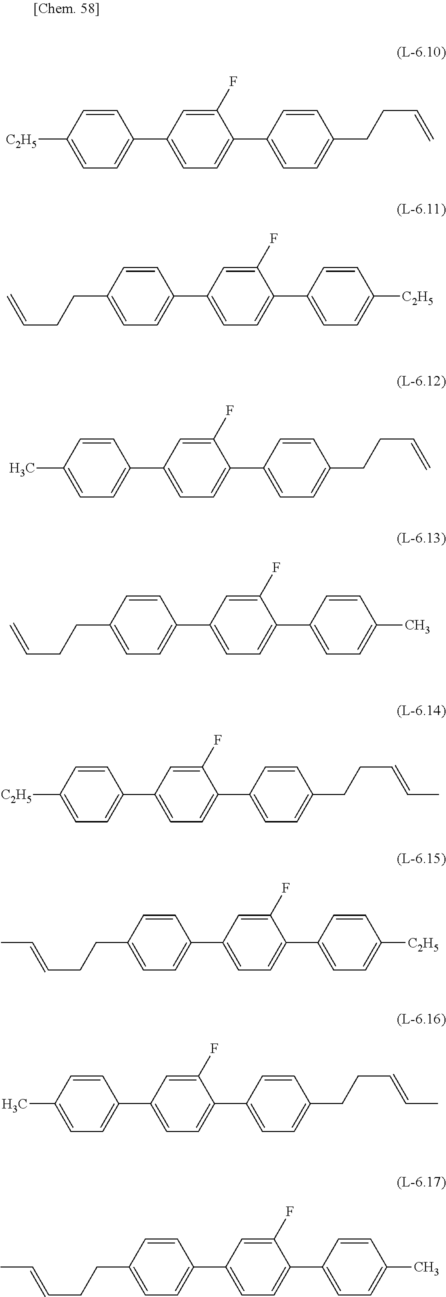

The preferable lower limit of the content of these compounds relative to the total of the composition of the present invention is 1%, 2%, 3%, 5%, or 7%. The preferable upper limit of the contents of these compounds is 20%, 15%, 13%, 10%, or 9%.

The compound represented by general formula (L-7) is the following compound:

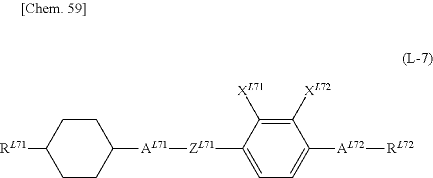

(In the formula, R^{L71} and R^{L72} are each independently the same as R^{L1} and R^{L2} in general formula (L), A^{L71} and A^{L72} are each independently the same as A^{L2} and A^{L3} in general formula (L), hydrogen atoms on A^{L71} and A^{L72} may each independently be substituted with a fluorine atom, Z^{L71} is the same as Z^{L72} in general formula (L), and X^{L71} and X^{L72} each independently represent a fluorine atom or a hydrogen atom.)

In the formula, R^{L71} and R^{L72} preferably each independently represent an alkyl group having 1 to 5 carbon atoms, an alkenyl group having 2 to 5 carbon atoms, or an alkoxy group having 1 to 4 carbon atoms, A^{L71} and A^{L72} preferably each independently represent a 1,4-cyclohexylene group or a 1,4-phenylene group, hydrogen atoms on A^{L71} and A^{L72} may each independently be substituted with a fluorine atom, Q^{L71} preferably represents a single bond or COO— and preferably represents a single bond, and X^{L71} and X^{L72} preferably each represent a hydrogen atom.

The number of compounds that can be used in combination is not particularly limited, and the compounds are appropriately combined depending on the desired performance, such as low-temperature solubility, transition temperature, electrical reliability, birefringence, etc. The number of compounds used is, for example, in one embodiment of the present invention, 1, 2, 3, or 4.

In the composition of the present invention, the content of the compound represented by general formula (L-7) must be adjusted according to the desired performance, such as low-temperature solubility, transition temperature, electrically reliability, birefringence, process compatibility, drop marks, image-sticking, dielectric anisotropy, etc.

The preferable lower limit of the content of the compound represented by formula (L-7) relative to the total of the composition of the present invention is 1%, 2%, 3%, 5%, 7%, 10%, 14%, 16%, or 20%. The preferable upper limit of the content of the compound represented by formula (L-7) relative to the total of the composition of the present invention is 30%, 25%, 23%, 20%, 18%, 15%, 10%, or 5%.

When an embodiment in which the composition of the present invention has high Tni is desirable, the content, of the compound represented by formula (L-7) is preferably relatively high, and when an embodiment in which the viscosity is low is desirable, the content is preferably relatively low.

Furthermore, the compound represented by general formula (L-7) is preferably compounds represented by formula (L-7.1) to formula (L-7.4), and is more preferably a compound represented by formula (L-7.2).

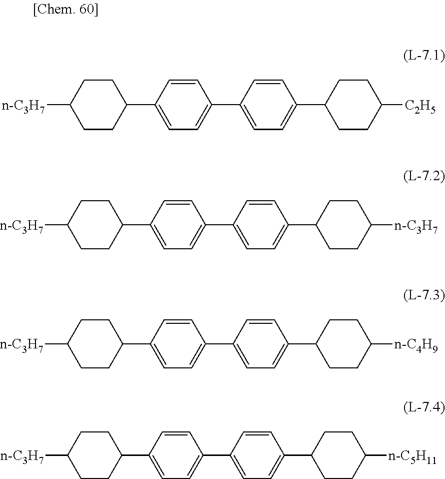

Furthermore, the compound represented by general formula (L-7) is preferably compounds represented by formula (L-7.11) to formula (L-7.13), and is more preferably a compound represented by formula (L-7.11).

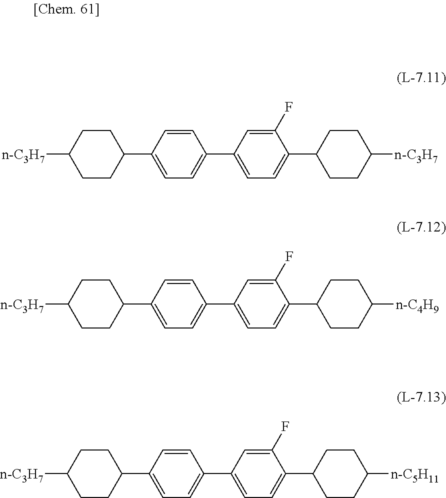

The compound represented by general formula (L-7) is preferably compounds represented by formulae (L-7.21) to (L-7.23). The compound represented by formula (L-7.21) is preferable.

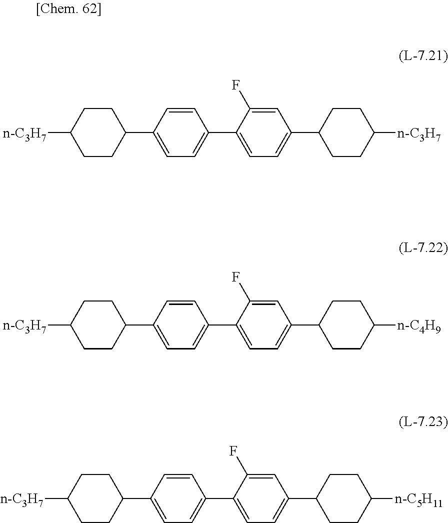

Furthermore, the compound represented by general formula (L-7) is preferably compounds represented by formula (L-7.31) to formula (L-7.34), and is more preferably a compound represented by formula (L-7.31) and/or formula (L-7.32).

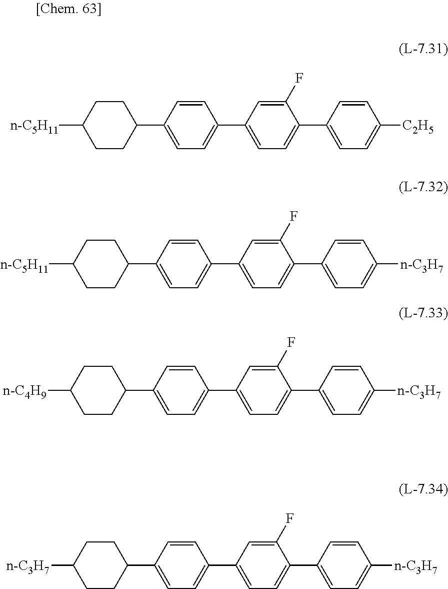

Furthermore, the compound represented by general formula (L-7) is preferably compounds represented by formula (L-7.41) to formula (L-7.44), and is more preferably a compound represented by formula (L-7.41) and/or formula (L-7.42).

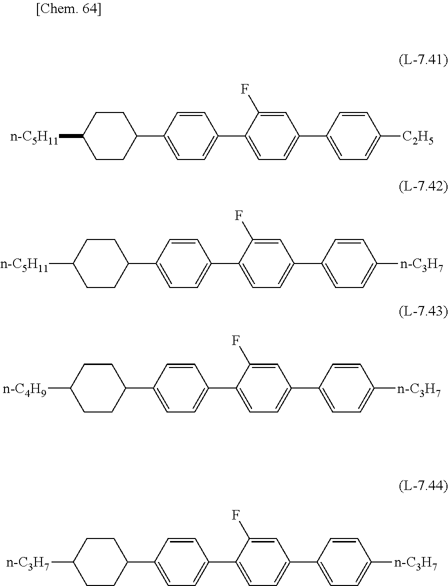

The composition of the present invention preferably contains one or two or more compounds selected from the group consisting of compounds represented by general formulae (N-1), (N-2), and (N-3). These compounds correspond to dielectrically negative compounds (the sign of Δε is minus and the absolute value is larger than 2).

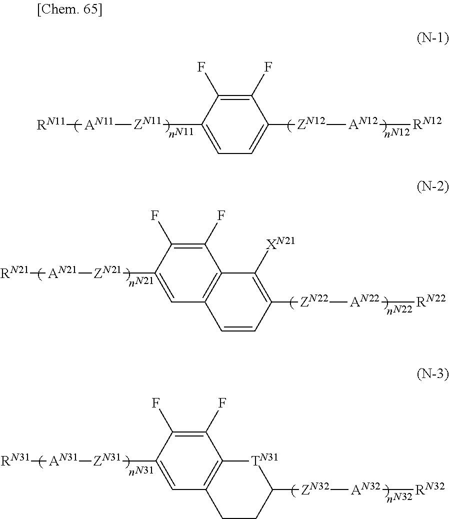

(In the formula, R^{N11}, R^{N12}, R^{N21}, R^{N22}, R^{N31}, and R^{N32} each independently represent an alkyl group having 1 to 8 carbon atoms, one —CH₂— or two or more non-adjacent —CH₂— in the alkyl group may each independently be substituted with —CH═CH—, —C═C—, —O—, —CO—, —COO—, or OCO—,

A^{N11}, A^{N12}, A^{N21}, A^{N22}, A^{N31}, and A^{N32} each independently represent a group selected from the group consisting of:
(a) a 1,4-cyclohexylene group (one —CH₂— or two or more non-adjacent —CH₂— present in this group may each be substituted with —O—) and
(b) a 1,4-phenylene group (one —CH═ or two or more non-adjacent —CH═ present in this group may each be substituted with —N═)
(c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═ present in the naphthalene-2,6-diyl group or the 1,2,3,4-tetrahydronaphthalene-2,6-diyl group may each be substituted with —N═),
where the group (a), the group (b), and the group (c) may each independently be substituted with a cyano group, a fluorine atom, or a chlorine atom,

Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═H—N═CH—, —CH═CH—, —CF═CF—, or C≡C—, and

X^{N21} represents a hydrogen atom or a fluorine atom,

T^{N31} represents —CH₂— or an oxygen atom,

n^{N11}, n^{N12}, n^{N21}, n^{N22}, n^{N31}, and n^{N32} each independently represent an integer of 0 to 3, n^{N11}+n^{N12}, n^{N21}+n^{N22}, and n^{N31}+n^{N32} are each independently 1, 2, or 3, and when multiple A^{N11} to A^{N32} and multiple Z^{N11} to Z^{N32} are present, they may be the same or different. However, from the compounds represented by general formula (N-1), compounds represented by general formula (i), general formula (ii), general formula (N-2), and general formula (N-3) are excluded. From the compounds represented by general formula (N-2), compounds represented by general formula (N-3) are excluded.

The compounds represented by general formulae (N-1), (N-2), and (N-3) are preferably compounds having negative Δε and an absolute value larger than 3.

In general formulae (N-1), (N-2), and (N-3), R^{N11}, R^{N12}, R^{N21}, R^{N22}, R^{N31}, and R^{N32} each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, more preferably each independently represent an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, more preferably each independently represent an alkyl group having 1 to 5 carbon atoms or an alkenyl group having 2 to 5 carbon atoms, yet more preferably each independently represent an alkyl group having 2 to 5 carbon atoms or an alkenyl group having 2 or 3 carbon atoms, and yet more preferably each independently represent an alkenyl group having 3 carbon atoms (propenyl group).

When the ring structures that they are bonded to are each a phenyl group (aromatic), a linear alkyl group having 1 to 5 carbon atoms, a linear alkoxy group having 1 to 4 carbon atoms, and an alkenyl group having 4 or 5 carbon atoms are preferable. When the ring structures they are bonded to are saturated ring structures, such as cyclohexane, pyran, or dioxane, a linear alkyl group having 1 to 5 carbon atoms, a linear alkoxy group having 1 to 4 carbon atoms, and a linear alkenyl group having 2 to 5 carbon atoms are preferable. In order to stabilise the nematic phase, the total number of carbon atoms and, if any, oxygen atoms is preferably 5 or less, and a linear structure is preferred.

The alkenyl group is preferably selected from the groups represented by formula (R1) to formula (R5). (In each formula, the dot represents a carbon atom in the ring structure.)

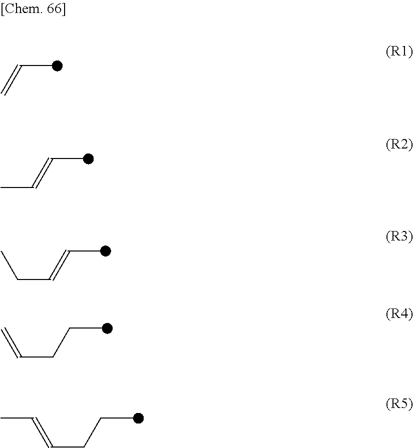

When increasing Δn is desirable, A^{N11}, A^{N12}, A^{N21}, A^{N22}, A^{N31}and A^{N32} are preferably aromatic. In order to improve the response speed, A^{N11}, A^{N12}, A^{N21}, A^{N22}, A^{N31}, and A^{N32} are preferably aliphatic. A^{N11}, A^{N12}, A^{N21}, A^{N22}, A^{N31}, and A^{N32} preferably each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and more preferably represent the following structure:

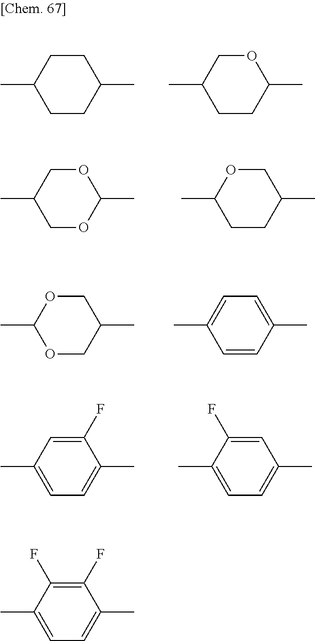

More preferably, A^{N11}, A^{N12}, A^{N21}, A^{N22}, A^{N31}, and A^{N32} each

represent a trans-1,4-cyclohexylene group or a 1,4-phenylene group.

Z^{N11}, Z^{N12}, Z^{N21}, Z^{N22}, Z^{N31}, and Z^{N32} preferably each independently represent —CH₂O—, —CF₂O—, —CH₂CH₂—, —CF₂CF₂—, or single bond, more preferably represents —CH₂O—, —CH₂CH₂—, or a single bond, and yet more preferably represents —CH₂O— or a single bond. X^{N21} preferably represents a fluorine atom. T^{N31} preferably represents an oxygen atom. n^{N11}+n^{N12}, n^{N21}+n^{N22}, and n^{N31}+n^{N32} are each preferably 1 or 2; and preferred are the combination of n^{N11} representing 1 and n^{N12} representing 0, the combination of n^{N11} representing 2 and n^{N12} representing 0, the combination of n^{N11} representing 1 and n^{N12} representing 1, the combination of n^{N11} representing 2 and n^{N12} representing 1, the combination of n^{N21} representing 1 and n^{N22} representing 0, the combination of n^{N21} representing 2 and n^{N22} representing 0, the combination of n^{N31} representing 1 and n^{N32} representing 0, and the combination of n^{N31} representing 2 and n^{N32} representing 0.

The preferable lower limit of the content of the compound represented by formula (N-1) relative to the total of the composition of the present invention is 1%, 10%, 20%, 30%, 40%, 50%, 55%, 60%, 65%, 70%, 75%, or 80%. The preferable upper limit of the content is 95%, 85%, 75%, 65%, 55%, 45%, 35%, 25%, or 20%.

The preferable lower limit of the content of the compound represented by formula (N-2) relative to the total of the composition of the present invention, is 1%, 10%, 20%, 30%, 40%, 50%, 55%, 60%, 65%, 70%, 75%, or 80%. The preferable upper limit of the content is 95%, 85%, 75%, 65%, 55%, 45%, 35%, 25%, or 20%.

The preferable lower limit of the content of the compound represented by formula (N-3) relative to the total of the composition of the present invention is 1%, 10%, 20%, 30%, 40%, 50%, 55%, 60%, 65%, 70%, 75%, or 80%. The preferable upper limit of the content is 95%, 85%, 75%, 65%, 55%, 45%, 35%, 25%, or 20%.

When the viscosity of the composition of the present invention needs to be maintained low and when a composition having high response speed is necessary, the lower limit is preferably low and trie upper limit is preferably low. When Tni of the composition of the present invention needs to be maintained high and when a composition with excellent temperature stability is necessary, the lower limit is preferably low and the upper limit is preferably low. When it is desirable to increase the dielectric anisotropy to maintain the drive voltage low, the lower limit is preferably high and the upper limit is preferably high.

The compound represented by general formula (N-1) is preferably a compound selected from the group consisting of compounds represented by general formulae (N-1-1) to (N-1-5).

The compound represented by general formula (N-1-1) is the following compound:

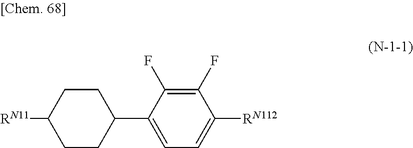

(In the formula, R¹¹¹ and R^{N112} are each independently the same as R^{N11} and R^{N12} in general formula (N).)

R^{N111} preferably represents an alkyl group having 1 to 5 carbon atoms or an alkenyl group having 2 to 5 carbon atoms, and preferably represents a propyl group or a pentyl group. R^{N112} preferably represents an alkyl group having 1 to 5 carbon atoms, an alkenyl group having 4 or 5 carbon atoms, or an alkoxy group having 1 to 4 carbon atoms, and preferably represents an ethoxy group or a butoxy group.

The compounds represented by general formula (N-1-1) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when TSI is important, it is highly effective to set the content relatively low. In order to improve drop marks and image-sticking properties, the range of the content is preferably set intermediate.

The preferable lower limit of the content of the compound represented by formula (N-1-1) relative to the total of the composition of the present invention is 5%, 10%, 13%, 15%, 17%, 20%, 23%, 25%, 27%, 30%, 33%, or 35%. The preferable upper limit of the content relative to the total of the composition of trie present invention is 50%, 40%, 38%, 35%, 33%, 30%, 28%, 25%, 23%, 20%, 18%, 15%, 13%, 10%, 8%, 7%, 6%, 5%, or 3%.

The compound represented by general formula (N-1-1) is preferably a compound selected from the group consisting of compounds represented by formula (N-1-1.1) to formula (N-1-1.14), is more preferably compounds represented by formulae (N-1-1.1) to (N-1-1.4), and is yet more preferably compounds represented by formula (N-1-1.1) and formula (N-1-1.3).

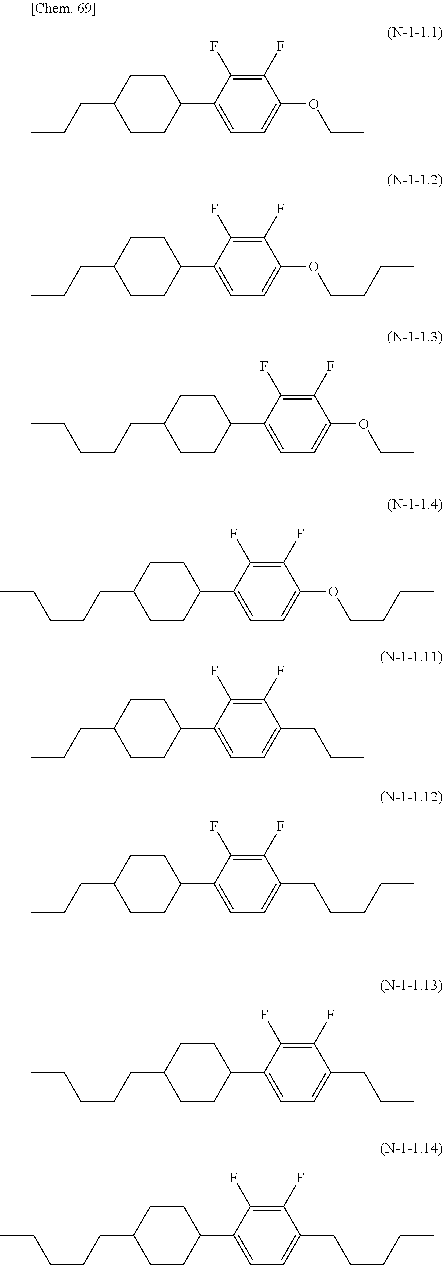

The compounds represented by formulae (N-1-1.1) to (N-1-1.4) can be used alone or in combination, and the preferable lower limit of the content of these compounds used alone or in combination relative to the total of the composition of the present invention is 5%, 10%, 13%, 15%, 17%, 20%, 23%, 25%, 27%, 30%, 33%, or 35%. The preferable upper limit of the content relative to the total of the composition of the present invention is 50%, 40%, 38%, 35%, 33%, 30%, 28%, 25%, 23%, 20%, 18%, 15%, 13%, 1.0%, 8%, 7%, 6%, 5%, or 3%.

The compound represented toy .general formula (N-1-2) is the following compound:

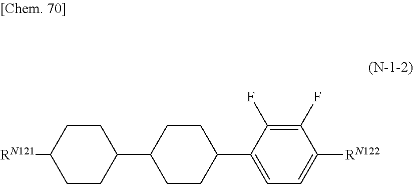

(In the formula, R^{N121} and R^{N122} are each independently the same as R^{N11} and R^{N12} in general formula (N).)

R^{N121} preferably represents an alkyl group having 1 to 5 carbon atoms or an alkenyl group having 2 to 5 carbon atoms, and preferably represents an ethyl group, a propyl group, a butyl group, or a pentyl group. R^{N122} preferably represents an alkyl group having 1 to 5 carbon atoms, an alkenyl group having 4 or 5 carbon atoms, or an alkoxy group having 1 to 4 carbon atoms, and preferably represents a methyl group, a propyl group, a methoxy group, an ethoxy group, or a propoxy group.

The compounds represented by general formula (N-1-2) can be used alone, or two or more compounds can be used in combination. The number of compounds that can be used in combination is not particularly limited, and the compounds are appropriately used in combination depending on the desired performance, such as iow-temperature soliibility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively low; and when T_{NI} is important, it is highly effective to set the content relatively high. In order to improve drop marks and image-sticking properties, the range of the content is preferably set intermediate.

The preferable lower limit of the content of the compound represented by formula (N-1-2) relative to the total of the composition of the present invention is 5%, 7%, 10%, 13%, 15%, 17%, 20%, 23%, 25%, 27%, 30%, 33%, 35%, 37%, 40%, or 42%. The preferable upper limit of the content relative to the total of the composition of the present invention is 50%, 48%, 45%, 43%, 40%, 38%, 35%, 33%, 30%, 28%, 25%, 23%, 20%, 18%, 15%, 13%, 10%, 8%, 7%, 6%, or 5%.

The compound represented by general formula (N-1-2) is preferably a compound selected from the group consisting of compounds represented by formula (N-1-2.1) to formula (N-1-2.13) and is more preferably compounds represented by formula (N-1-2.3) to formula (N-1-2.7), formula (N-1-2.10), formula (N-1-2.11), and formula (N-1-2.13); when improving Δε is important, the compounds represented by formula (N-1-2.3) to formula (N-1-2.7) are preferable; and when improving T_{NI} is important, compounds represented by formula (N-1-2.10), formula (N-1-2.11), and formula (N-1-2.13) are preferable.

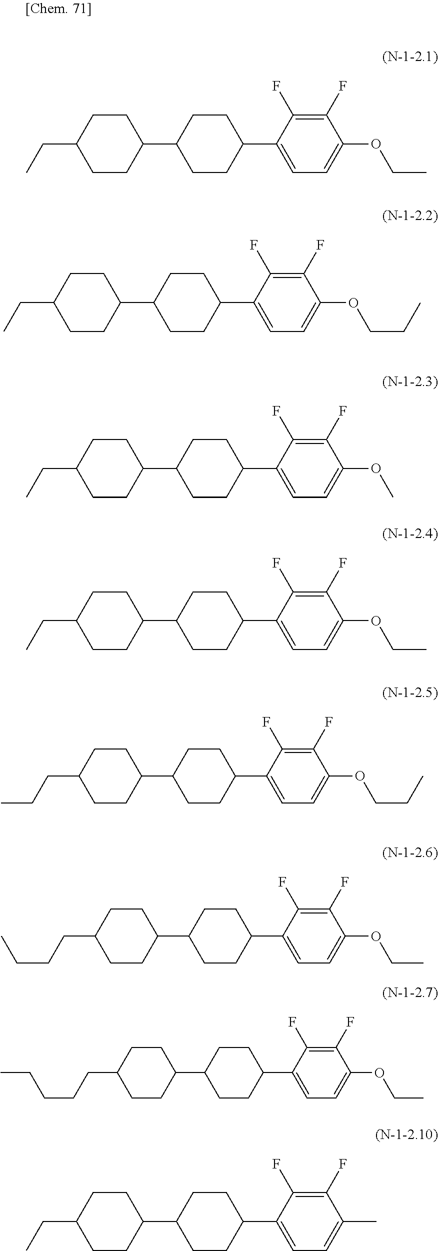

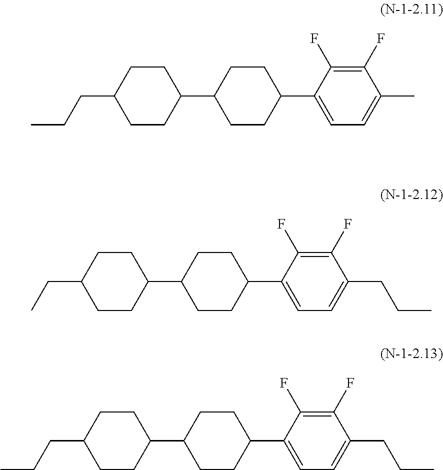

The compounds represented by formulae (N-1-2.1) to (N-1-2.13) can be used alone or in combination, and the preferable lower limit of the content of these compounds used alone or in combination relative to the total of the composition of the present invention is 5%, 10%, 13%, 15%, 17%, 20%, 23%, 25%, 27%, 30%, 33%, or 35%. The preferable upper limit of the content relative to the total of the composition of the present invention is 50%, 40%, 38%, 35%, 33%, 30%, 28%, 25%, 23%, 20%, 18%, 15%, 13%, 10%, 8%, 7%, 6%, 5%, or 3%.

The compound represented by general formula (N-1-3) is the following compound:

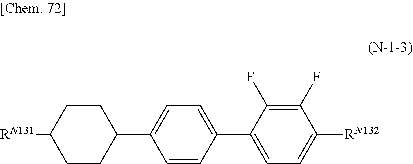

(In the formula, R^{N131} and R^{N132} are each independently the same as R^{N11} and R^{N12} in general formula (N).)

R^{N131} preferably represents an alkyl group having 1 to 5 carbon atoms or an alkenyl group having 2 to 5 carbon atoms, and preferably represents an ethyl group, a propyl group, or a butyl group. R^{N132} preferably represents an alkyl group having 1 to 5 carbon atoms, an alkenyl group having 4 or 5 carbon atoms, or an: alkoxy group having 1 to 4 carbon atoms, and preferably represents an ethoxy group, at propoxy group, or at butoxy group.

The compounds represented by general formula (N-1-3) can be used alone, or two or more compounds can be used in combination. The number of compounds that can be used in combination is not particularly limited, and the compounds aire appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

A liquid crystal composition containing a compound represented by general formula (N-1-3) and compounds represented by general formula (i) and general formula (ii) is particularly preferable not only from the viewpoint of low viscosity but also from the viewpoints of Δn and Tni.

When improving Δε is important, the content is preferably set relatively high; when low-temperature solubility is important, it is highly effective to set the content relatively high; and when T_{NI} is important, it is highly effective to set the content relatively high. In order to improve drop marks and image-sticking properties, the range of the content is preferably set intermediate.

The preferable lower limit of the content of the compound represented by formula (N-1-3) relative to the total of the composition of the present invention is 1%, 3%, 4%, 5%, 5%, 7%, 8%, 9%, 10%, 12%, 13%, 15%, 16%, 17%, 18%, or 20%. The preferable upper limit of the content relative to the total of the composition of the present invention is 40%, 35%, 32%, 30%, 28%, 26%, 25%, 23%, 20%, 18%, 15%, or 13%.

The compound represented by general formula (N-1-3) is preferably a compound selected frost the group consisting of compounds represented by formula (N-1-3.1) to formula (N-1-3.11), is more preferably compounds represented by formulae (N-1-3.1) to (N-1-3.7), and is yet more preferably compounds represented by formula (N-1-3.1), formula (N-1-3.2), formula (N-1-3.3), formula (N-1-3.4), and formula (N-1-3.6).

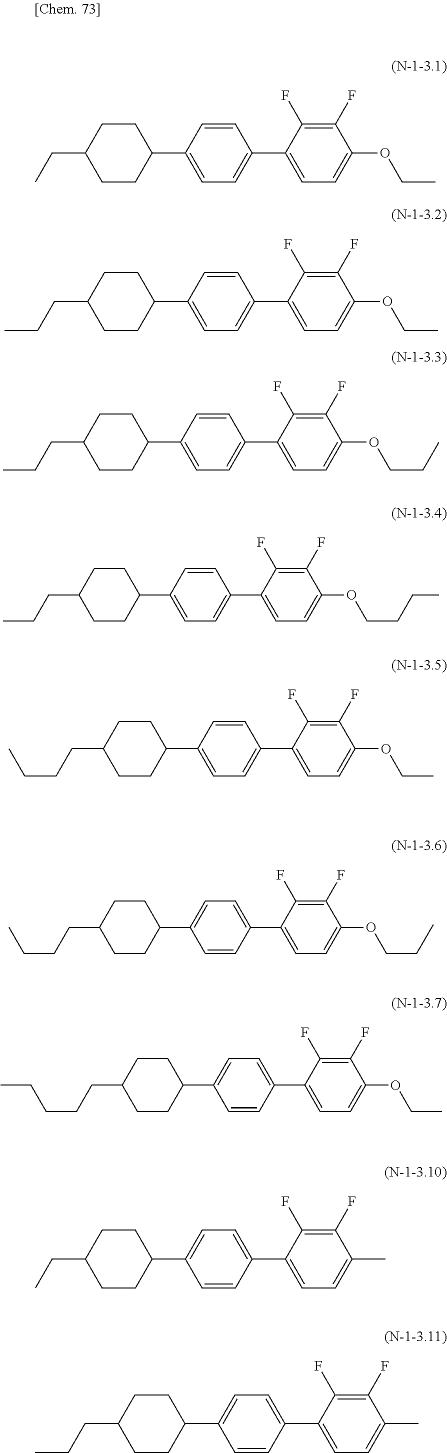

The compounds represented by formula (N-1-3.1) to formula (N-1-3.4) and formula (N-1-3.6) can be used alone or in combination, but the combination of formula (N-1-3.1) and formula (N-1-3.2) and the combination of two or three compounds selected from formula (N-1-3.3), formula (N-1-3.4) and formula (N-1-3.6) are preferable. The preferable lower limit of the content of these compounds alone or in combination relative to the total of the composition of the present invention is 5%, 10%, 13%, 15%, 17%, or 20%. The preferable upper limit of the content relative to the total of the composition of trie present invention is 35%, 30%, 28%, 25%, 23%, 20%, 18%, 15%, or 13%.

The compound represented by general formula (N-1-4) is the following compound:

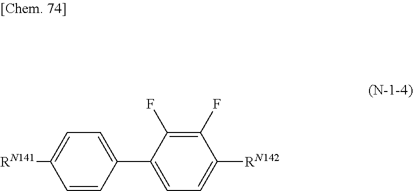

(In the formula, R^{N141} and R^{N142} are each independently the same as R^{N11} and R^{N12} in general formula (N).)

R^{N141} and R^{N142} preferably each independently represent an alkyl group having 1 to 5 carbon atoms, an alkenyl group having 4 or 5 carbon atoms, or an alkoxy group having 1 to 4 carbon atoms, and preferably each independently represent a methyl group, a propyl group, an ethoxy group, or a butoxy group.

The compounds represented by general formula (N-1-4) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively high; and when T_{NI} is important, it is highly effective to set the content relatively low. In order to improve drop marks and image-sticking properties, the range of the content is preferably set intermediate.

The preferable lower limit of the content of the compound represented by formula (N-1-4) relative to the total of the composition of the present invention is 3%, 5%, 7%, 10%, 13%, 15%, 17%, or 20%. The preferable upper limit of the content relative to the total of the composition of the present invention is 35%, 30%, 28%, 25%, 23%, 20%, 18%, 15%, 13%, 11%, 10%, or 8%.

The compound represented by general formula (N-1-4) is preferably a compound selected from the group consisting of compounds represented by formula (N-1-4.1) to formula (N-1-4.14), is more preferably compounds represented by formulae (N-1-4.1) to (N-1-4.4), and is yet more preferably compounds represented by formula (N-1-4.1) and formula (N-1-4.2).

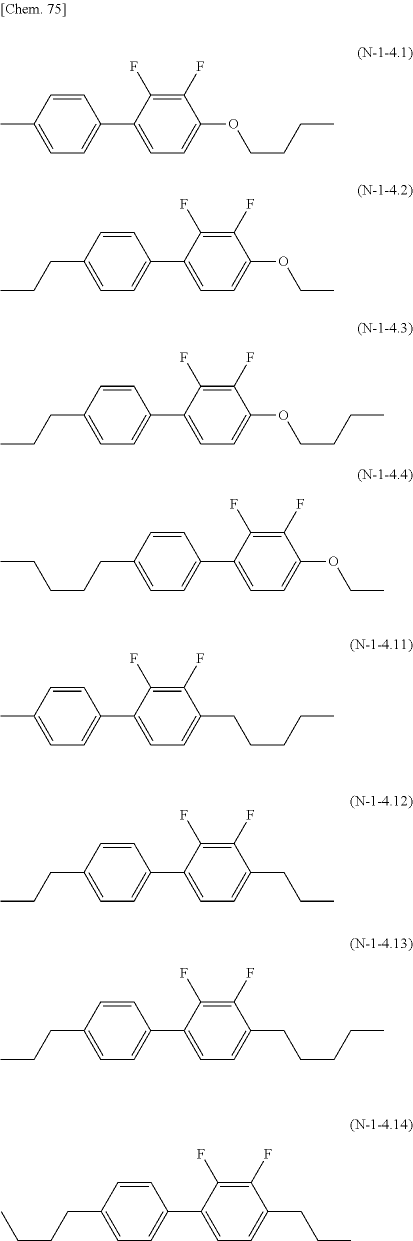

The compounds represented by formula (N-1-4.1) to formula (N-1-4.4) can be used alone or in combination, and the preferable lower limit of the content of these compounds used alone or in combination relative to the total of the composition of the present invention is 3%, 5%, 7%, 10%, 13%, 15%, 17%, or 20%. The preferable upper limit of the content relative to the total of the composition of the present invention is 35%, 30%, 28%, 25%, 23%, 20%, 18%, 15%, 13%, 11%, 10%, or 8%.

The compound represented by general formula (N-1-5) is the following compound:

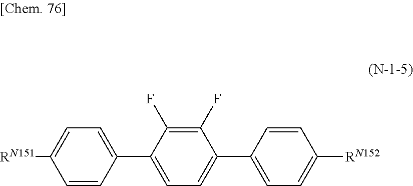

(In the formula, R^{N151} and R^{N152} are each independently the same as R^{N11} and R^{N12} in general formula (N).)

R^{N151} and R^{N152} preferably each independently represent an alkyl group having 1 to 5 carbon atoms, an alkenyl group having 4 or 5 carbon atoms, or an alkoxy group having 1 to 4 carbon atoms, and preferably each independently represent an ethyl group, a propyl group, or a butyl group.

The compounds represented by general formula (N-1-5) can be used alone, or two or more compounds can be used in combination. The number of compounds that can be used in combination is not particularly limited, and the compounds are appropriately used in combination depending on the desired performance, such as low-temperature solubility, transition temperature, electrical reliability, birefringence, etc. The number of compounds used is, for example, in one embodiment of the present invention, 1, 2, 3, 4, or 5 or more.

When improving Δε is important, the content is preferably set relatively high; when low-temperature solubility is important, it is highly effective to set the content relatively low; and when R_{NI} is important, it is highly effective to set the content relatively high. In order to improve drop marks and image-sticking properties, the range of the content is preferably set intermediate.

The preferable lower limit of the content of the compound represented by formula (N-1-5) relative to the total of the composition of the present invention is 3%, 4%, 5%, 6%, 7%, 8%, 10%, 13%, 15%, 17%, or 20%. The preferable upper limit of the content relative to the total of the composition of the present invention is 35%, 33%, 30%, 28%, 25%, 23%, 20%, 18%, 17%, 15%, 14%, 13%, 12%, or 11%.

The compound represented by general formula (N-1-5) is preferably a compound selected from the group consisting of compounds represented by formula (N-1-5.1) to formula (N-1-5.6), and is more preferably compounds represented by formulae (N-1-5.2 and (N-1-5.4).

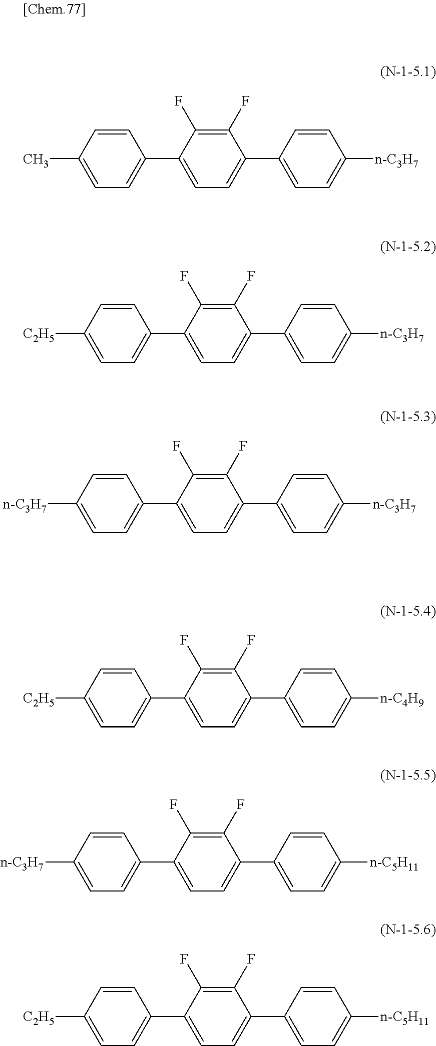

The compounds represented by formula (N-1-5.2 and formula (N-1-5.4) can be used alone or in combination, and the preferable lower limit of the content of these compounds used alone or in combination relative to the total of the composition of the present invention is 5%, 8%, 10%, 13%, 15%, 17%, or 20%. The preferable upper limit of the content relative to the total of the composition of the present invention is 35%, 33%, 30%, 28%, 25%, 23%, 20%, 18%, 15%, or 13%.

The compound represented by general formula (N-2) is preferably a compound selected from the group consisting of compounds represented by general formulae (N-2-1) to (N-2-3).

The compound represented by general formula (N-2-1) is the following compound:

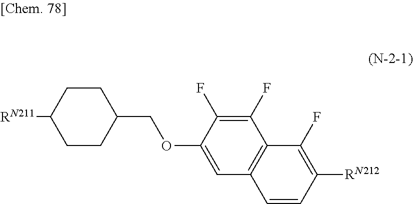

(In the formula, R^{N211} and R^{N212} are each independently the same as R^{N11} and R^{N12} in general formula (N).)

The compound represented by general formula (N-2-2) is the following compound:

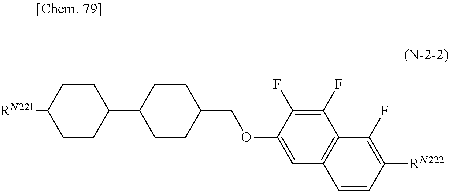

(In the formula, R^{N221} and R^{N222} are each independently the same as R^{N11} and R^{N12} in general formula (N).)

The compound represented by general formula (N-2-3) is the following compound:

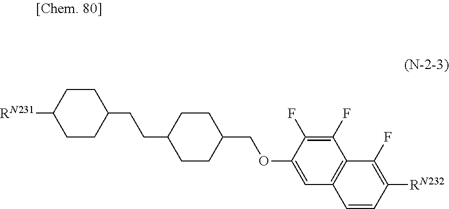

(In the formula, R^{N231} and R^{N232} are each independently the same as R^{N11} and R^{N12} in general formula (N).)

The compound represented by general formula (N-3) is preferably a compound selected from the group consisting of compounds represented by general formulae (N-3-1) to (N-3-2).

The compound represented by general formula (N-3-1) is the following compound:

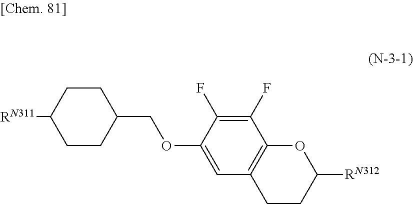

(In the formula, R^{N311} and R^{N312} are each independently the same as R^{N11} and R^{N12} in general formula (N).)

The compound represented by general formula (N-3-2) is the following compound:

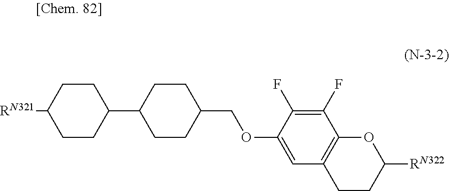

(In the formula, R^{N321} and R^{N322} are each independently the same as R^{N11} and R^{N12} in general formula (N).)

The liquid crystal composition of the present invention may contain, in addition to the compounds described above, common nematic liquid crystals, smectic liquid crystals, cholesteric liquid crystals, antioxidants, UV absorbers, etc.

The liquid crystal composition of the present invention may further contain a polymerizable compound. In this manner, the composition can be used as a liquid crystal composition for PSA mode, PSVA mode, PS mode, or the like. In this case, preferably 0.01 to 2% by mass of the polymerizable compound is contained. More specifically, the liquid crystal composition of the present invention preferably contains one or two or more polymerizable compounds represented by general formula (RM-1).

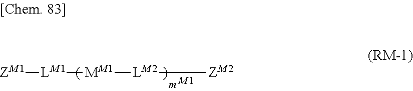

In the formula, Z^{M1} and Z^{M2} each independently represent:

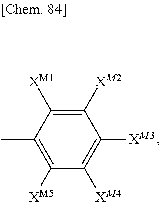

X^{M1} to X^{M5} each represent hydrogen, fluorine, or

—S^{M1}—R^{M1} [Chem. 85]

and, in Z^{M1} and Z^{M2}, at least one of Z^{M1} to X^{M5} preferably represents:

—S^{M1}—R^{M1} [Chem. 86]

S^{M1} represents an alkyl group having 1 to 12 carbon atoms or a single bond, and the methylene group in the alkyl group may be substituted with an oxygen atom, —COO—, —OCO—, or OCOO— provided that the oxygen atoms are not directly bonded to each other.

R^{M1} represents one of compounds represented by formula (R-1) to formula (R-15):

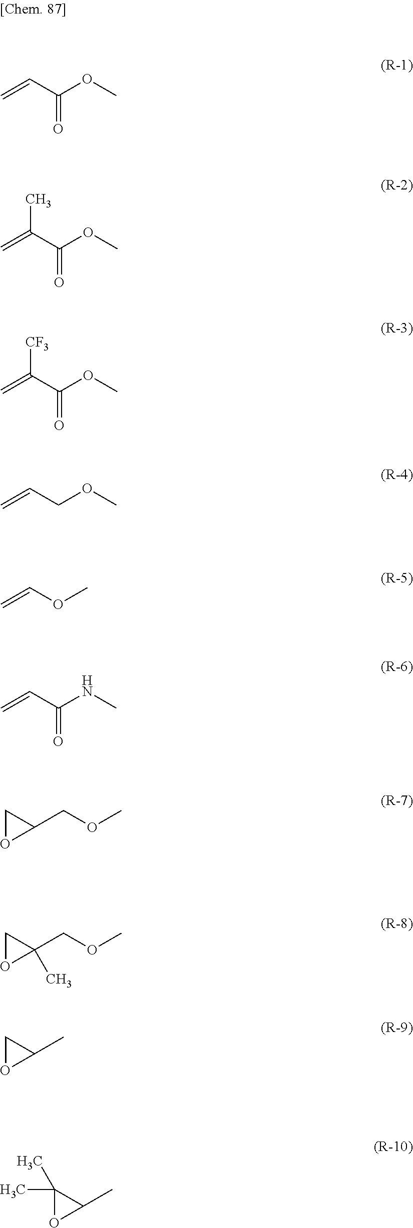

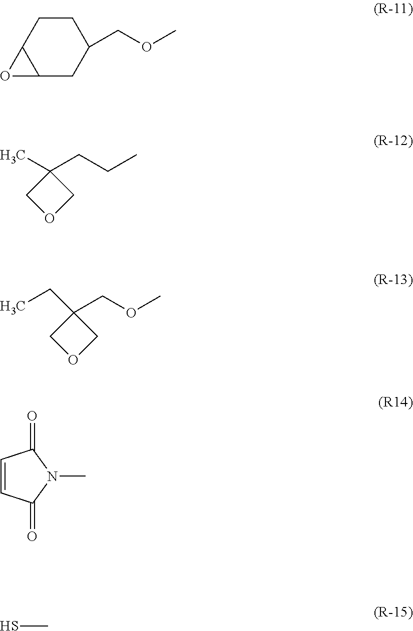

But preferably R^{M1} represents the compound represented by formula (R-1) or formula (R-2).

L^{M1} and L^{M2} each independently represent a single bond, —O—, —CH₂—, —OCH₂—, —CH₂O—, —CO—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —OCOCH₂—, —CH₂COO—, —CH═CH—, —CF═CH—, —CH═CF—, —CF═CF—, —CF₂—, —CF₂O', —OCF₂—, —CF₂CH₂—, —CH₂CF₂—, —CF₂CF₂—, or C≡C—; and when multiple L^{M2} are present, they may be the same or different. However, L^{M1} and L^{M2} preferably each independently represent a single bond, —OCH₂—, —CH₂O—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —CF₂O—, —OCF₂—, or C≡C—, and more preferably each independently represent a single bond, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, or C₂H₄COO—.

M^{M1}, when present, represents a 1,4-phenylene group, a 1,4-cyclohexylene group, or a naphthalene-2,6-diyl group, and hydrogen atoms contained in these groups may each be substituted with a fluorine atom, a chlorine atom, an alkyl group having 1 to 8 carbon atoms, a halogenated alkyl group, a halogenated alkoxy group, an alkoxy group, a nitro group, or

—S^{M1}—R^{M1} [Chem. 88]

and when multiple M^{M1} are present, they may be the same or different; however, M^{M1} preferably represents a 1,4-phenylene group, which is unsubstituted or which has a hydrogen atom substituted with a fluorine atom, an alkyl group having 1 to 8 carbon atoms, or an alkoxy group. In this case, when multiple are present, they may be the same or different.

m^{M1} represents 0, 1, or 2, but preferably represents 0 or 1. More specifically, examples of the compound, which is a polymerizable compound, represented by general formula (RM-1) include compounds represented by the following general formula (RM-1A):

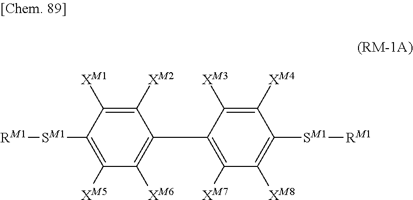

(In the formula, R^{M1} and S^{M1} are each independently the same as R^{M1} and S^{M1} in general formula (RM-1), and X^{M1} to X^{M5} each represent hydrogen, fluorine, or

—S^{M1}—R^{M1} [Chem. 90]

In the compound, represented by general formula (RM-1A), the structure of the biphenyl skeleton is either unsubstituted or represented by formula (IV-11) to formula (IV-14), and is preferably unsubstituted or represented by formula (IV-11).

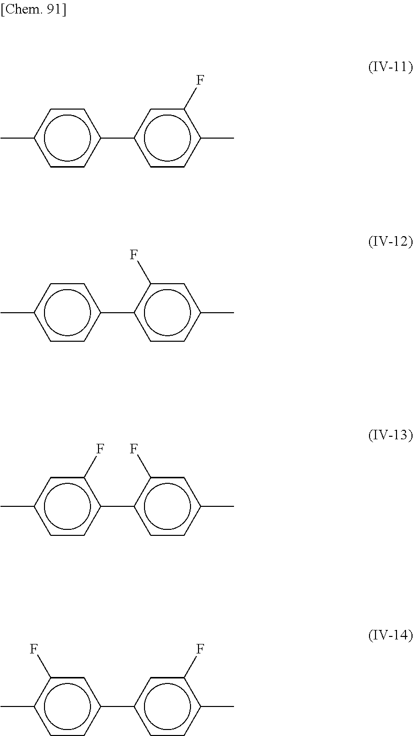

When a liquid crystal composition that contains a polymerizable compound containing a biphenyl skeleton unsubstituted or represented by formula (IV-11) to formula (IV-14) is used, the alignment regulating force in a liquid crystal, display device of PSA mode, PSVA mode, PS mode, or the like becomes optimum, and an excellent alignment state is obtained.

Examples of the compound represented by general formula (RM-1) also include compounds represented by general formula (RM-1B):

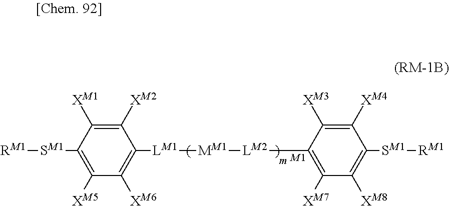

(In the formula, R^{M1}, S^{M1}, L^{M1}, L^{M2}, M^{M1}, and m^{M1} are the same as R^{M1}, S^{M1}, L^{M1}, L^{M2}, M^{M1}, and m^{M1} in general formula (RM-1), and X^{M1} to X^{M5} each represent hydrogen, fluorine, or

—S^{M1}—R^{M1} [Chem. 93]

As the compound represented by general formula (RM-1), which is a polymerizable compound, the compounds represented by the following structural formulae (M1-1) to (M10-13), (M2-1) to (M2-8), (M3-1) to (M3-6), (M4-1) to (M4-7), and (I-1) to (I-40) are preferable:

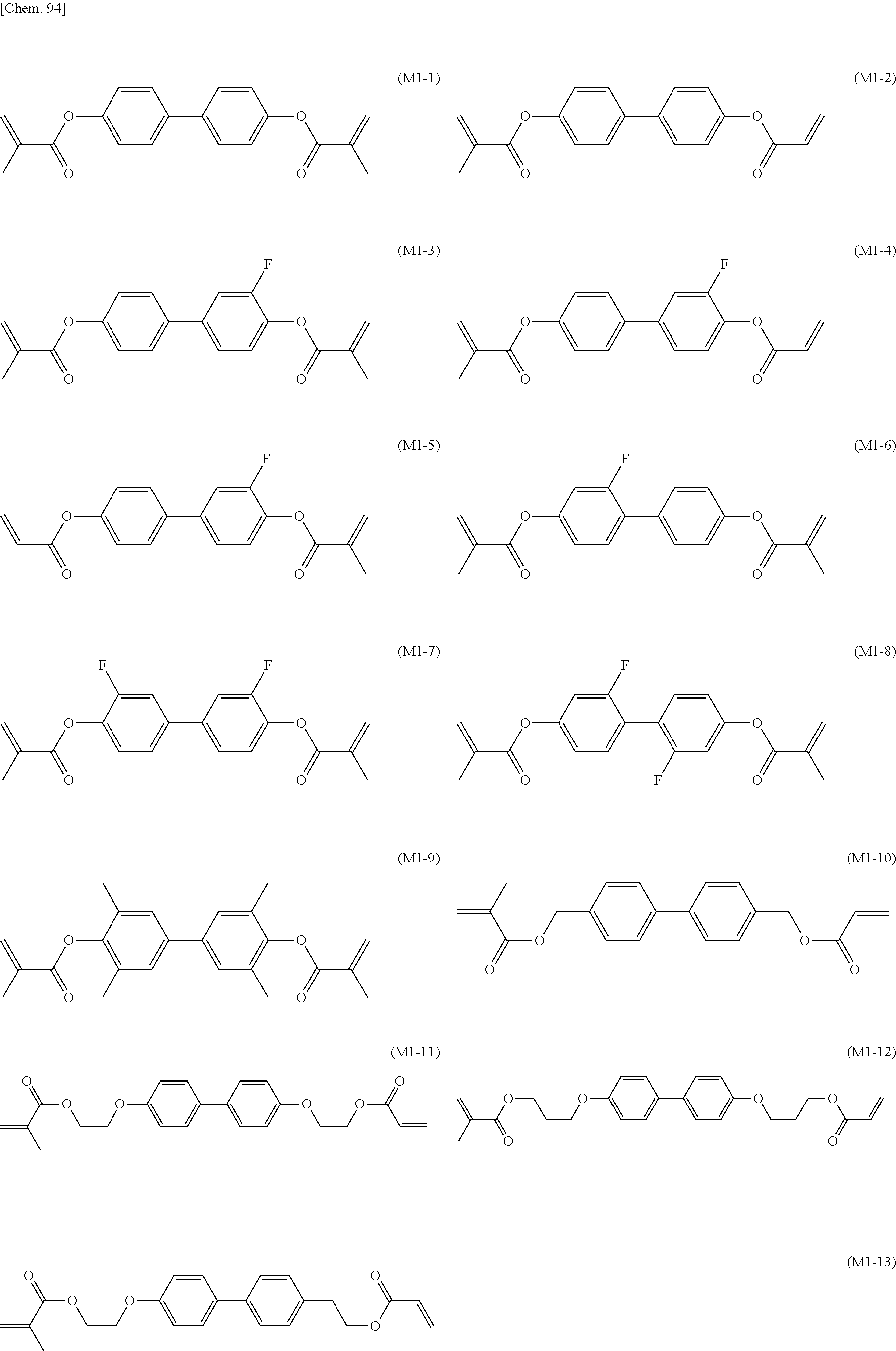

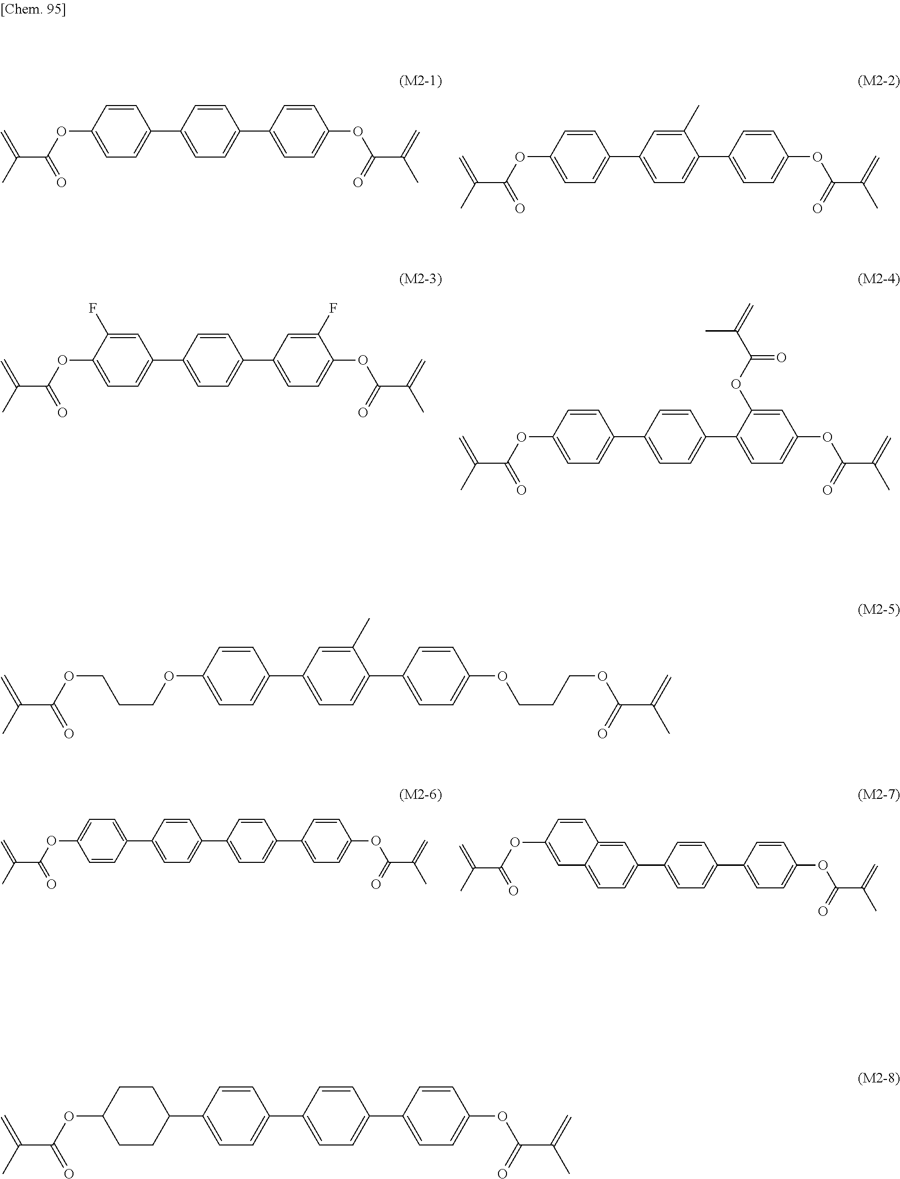

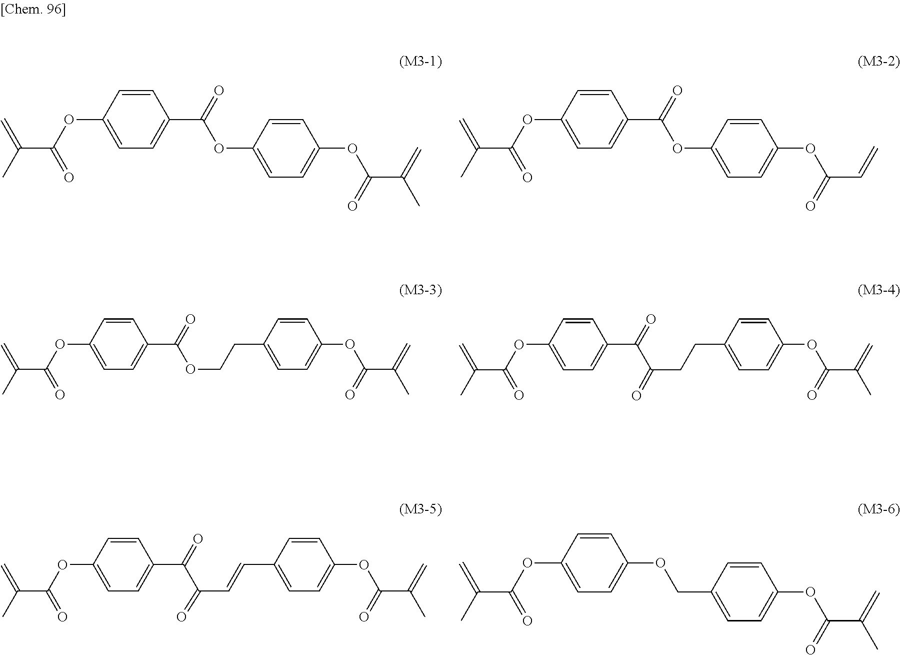

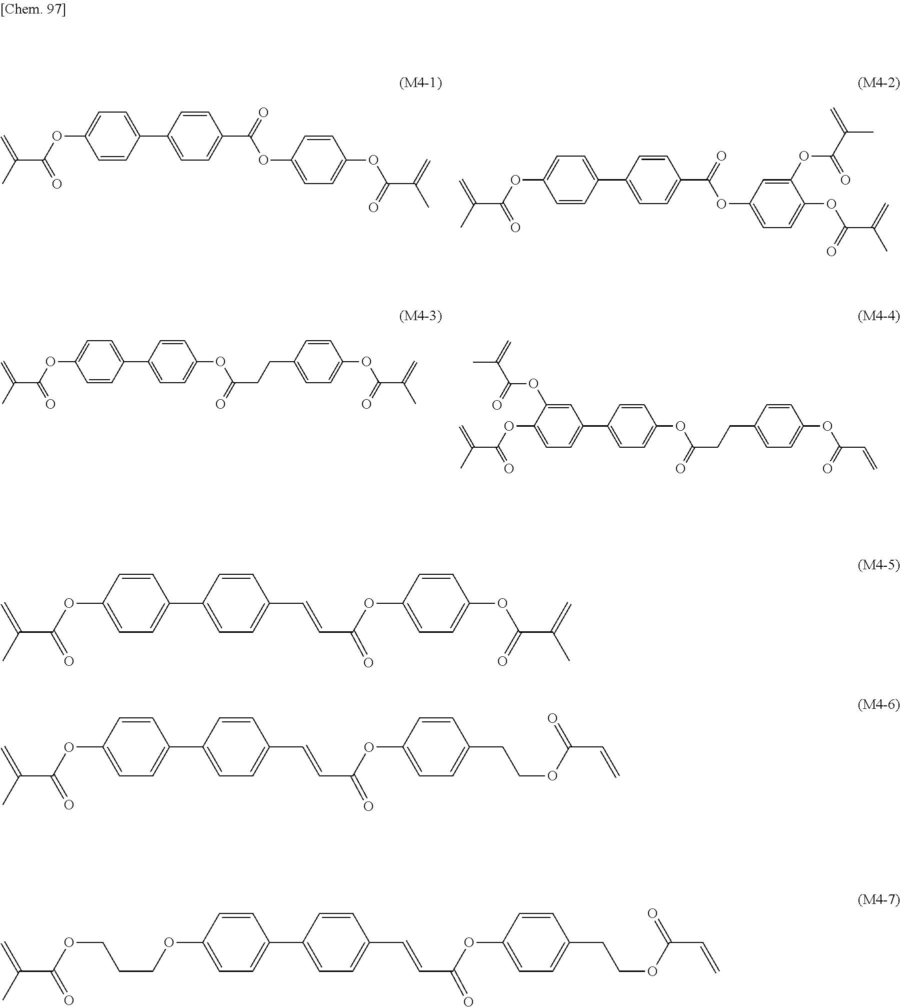

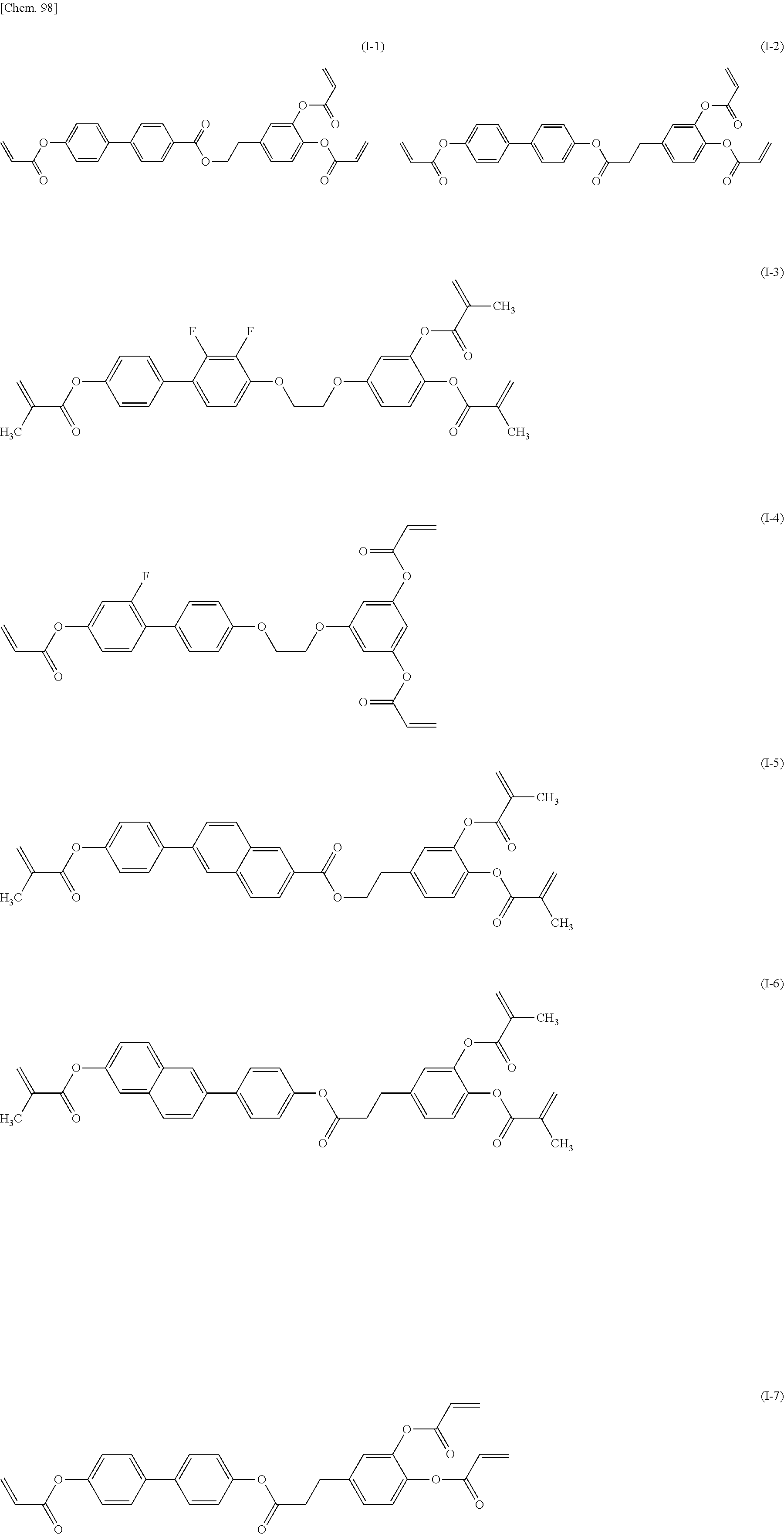

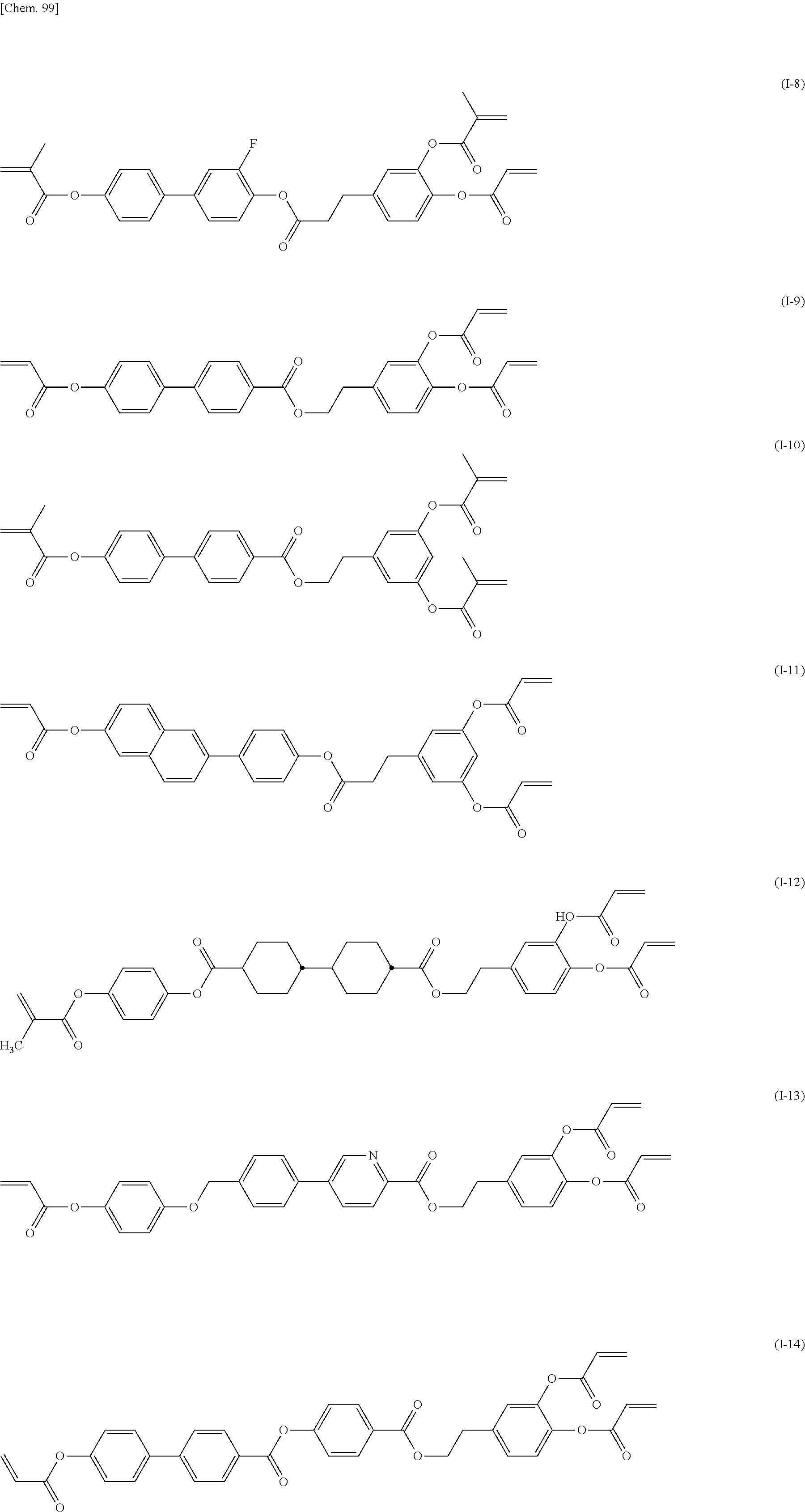

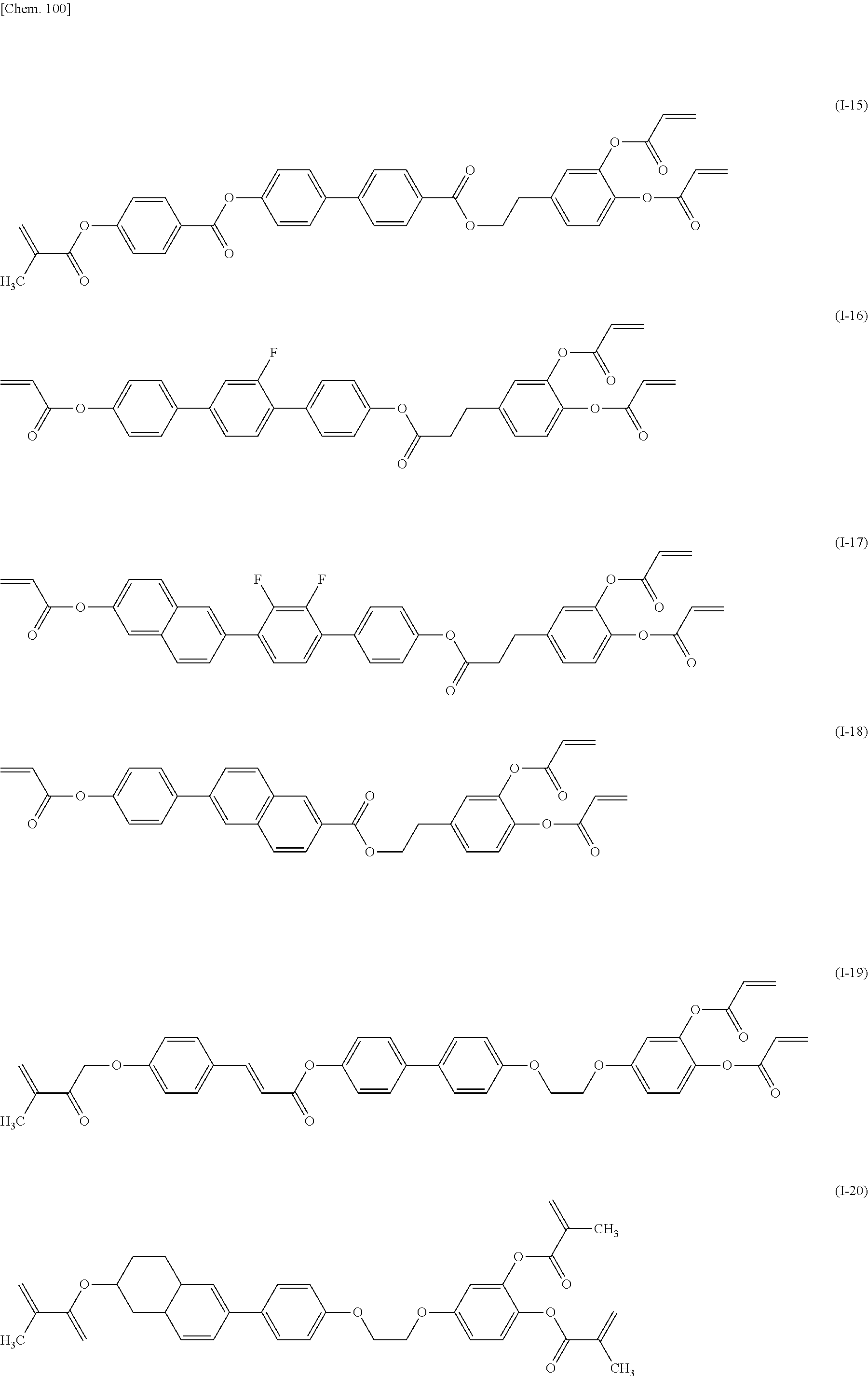

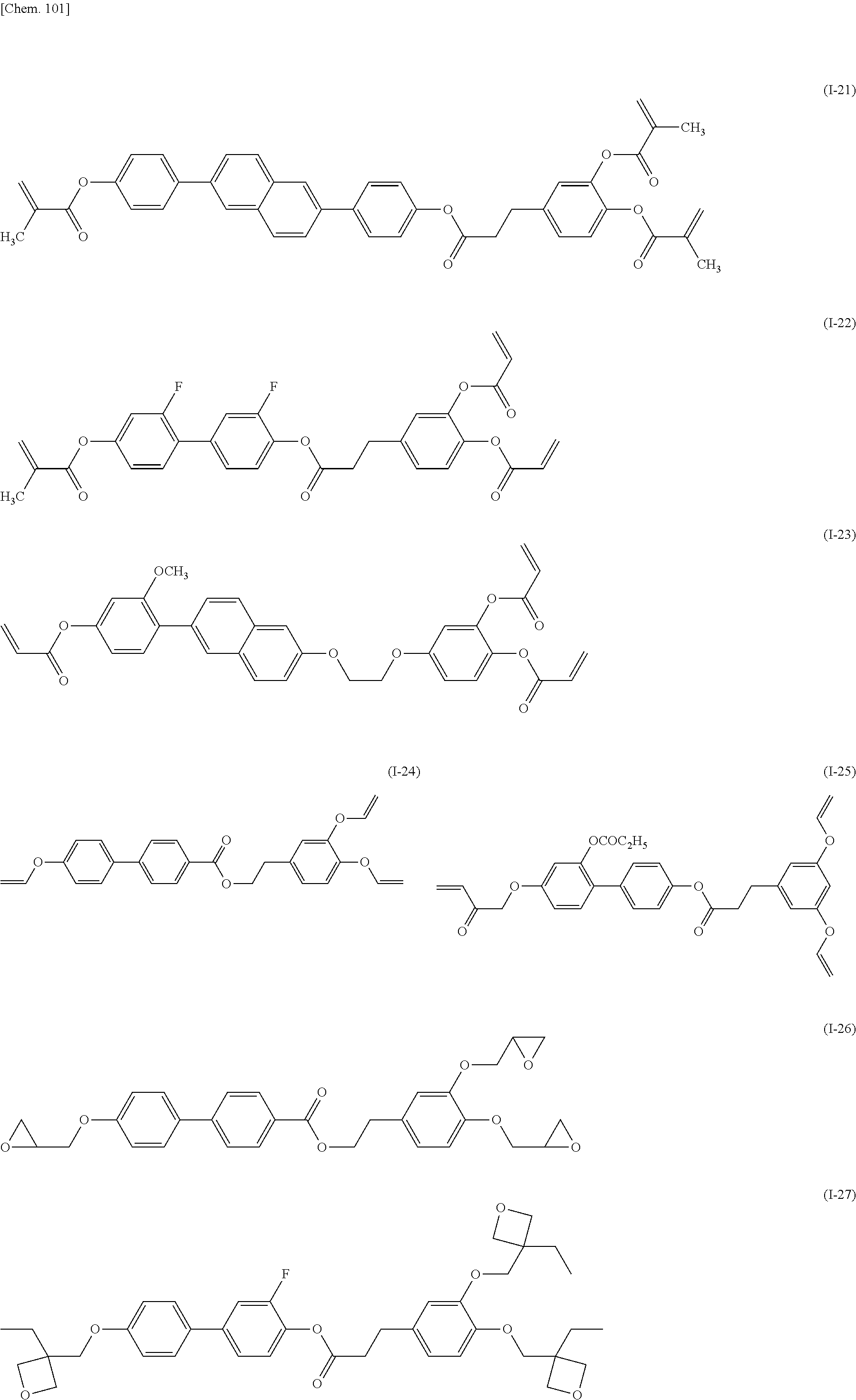

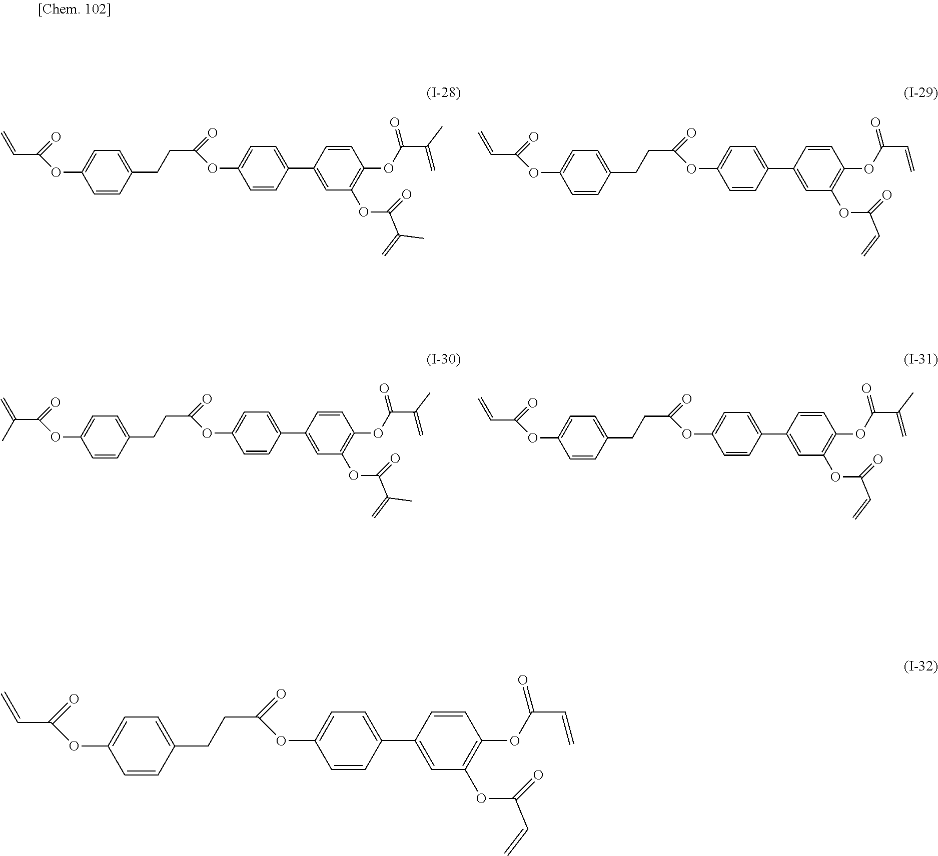

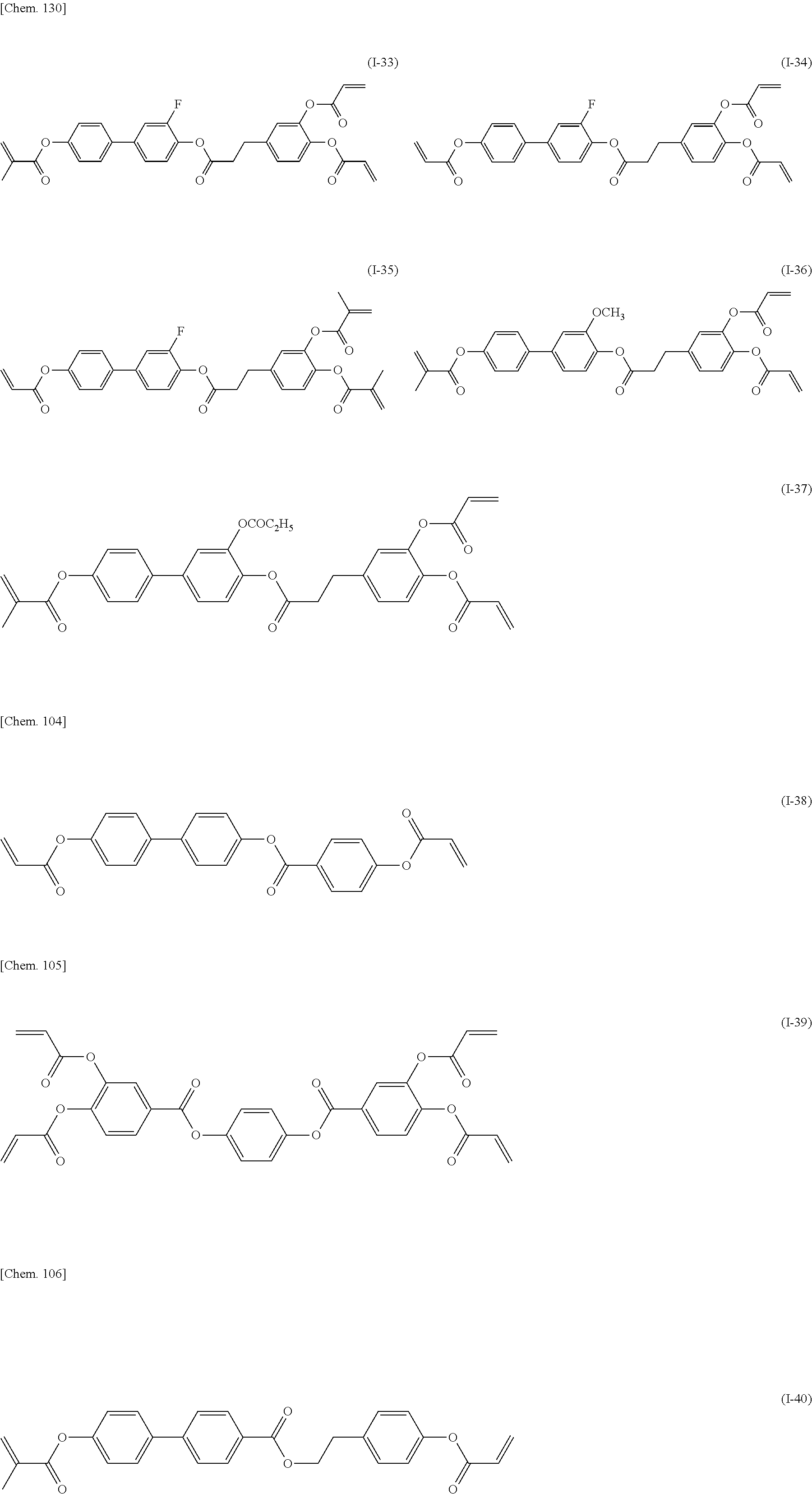

Furthermore, the compounds represented by (M1-1) to (M1-8), (M1-10) to (M1-13), (M2-2) to (M2-5), (M3-1), (M3-4), (M3-5), (M4-1), (M4-2), (M4-4), (M4-6), (M4-7), (I-1) to (I-11), (I-22) to (I-25), and (I-28) to (I-40) are preferable. In particular, the compounds represented by (M1-1), (M1-3), (M1-6) to (M1-8), (M1-11), (M1-12), (M2-2), (M2-4), (M3-1), (M3-5), (M4-2), (M4-6), (M4-7), and (I-33) to (I-37) are preferable.

A polymerizable compound-containing liquid crystal composition that simultaneously contains a compound represented by general formula (I) and a compound represented by general formula (RM-1) obtains a low viscosity (η), a low rotational viscosity (γ₁), a high elastic constant (K33), and a high VHR, and thus a liquid crystal display device of PSA mode or PSVA mode using this composition can achieve both high-speed response and high reliability. Thus, those compounds are preferably simultaneously contained. More preferably, compounds represented by general formula (I) and general formula (N-3), and a polymerizable compound represented by general formula (RM-1) are simultaneously contained. More preferably, compounds represented by general formula (I), general formula (N-3), and general formula (II), and a polymerizable compound represented by general formula (RM-1) are simultaneously contained. More preferably, compounds represented by general formula (I), general formula (N-3), and general formula (II), a compound selected from the group consisting of general formulae (IV-1) to (IV-3), and a polymerizable compound represented by general formula (RM-1) are simultaneously contained. More preferably, compounds represented by general formula (I), general formula (N-3), general formula (II), and general formula (V), a compound selected from the group consisting of general formula (IV-1) to (IV-3), and a polymerizable compound represented by general formula (RM-1) are simultaneously contained. More preferably, compounds represented by general formula (I), general formula (N-3), general formula (II), and general formulae (Np-1) and (Np-2), a compound selected from the group consisting of general formulae (IV-1) to (IV-3), and a polymerizable compound represented by general formula (RM-1) are simultaneously contained. More preferably, compounds represented by general formula (I), general formula (N-3), general formula (II), general formula (V), and general formulae (Np-1) and (Np-2), a compound selected from the group consisting of general formulae (IV-1) to (IV-3), and a polymerizable compound represented by general formula (RM-1) are simultaneously contained.

A liquid crystal display device that uses the liquid crystal composition of the present invention has a prominent feature, such as high-speed response, and is particularly useful for active matrix driving liquid crystal display devices. It can be applied to VA mode, PSVA mode, PSA mode, IPS mode, FFS mode, or ECB mode. The liquid crystal composition of the present invention is more preferably applied to a liquid crystal display device of IPS mode or FFS mode. In other words, when the liquid crystal composition of the invention of the present application is used in a liquid crystal display device of IPS mode or FFS mode, transmittance and high-speed response can be significantly improved.

### EXAMPLES

The present invention will now be described in further details by way of examples below which do not limit the present invention. In the description below, “%” used for compositions of Examples and Comparative Examples means “% by mass”. In Examples, following abbreviations are used to describe compounds.

(Side chain)

-n —CₙH₂ₙ₊₁ linear alkyl group having n carbon atoms

n- CₙH₂ₙ₊₁— linear alkyl group having n carbon atoms

-On —OCₙH₂ₙ₊₁ linear alkoxyl group having n carbon atoms

nO- CₙH₂ₙ₊₁O— linear alkoxyl group having n carbon atoms

-A- C₂H₄—

-1O- —CH₂O—

-V —CH═CH₂

V- CH₂═CH—

-V1 —CH═CH—CH₃

1V- CH₃—CH═CH—

-2V —CH₂—CH₂—CH═CH₃

V2- CH₃═CH—CH₂—CH₂—

-2 V1 —CH₂—CH₂—CH═CH—CH₃

1V2- CH₃—CH═CH—CH₂—CH₂

(Ring structure)

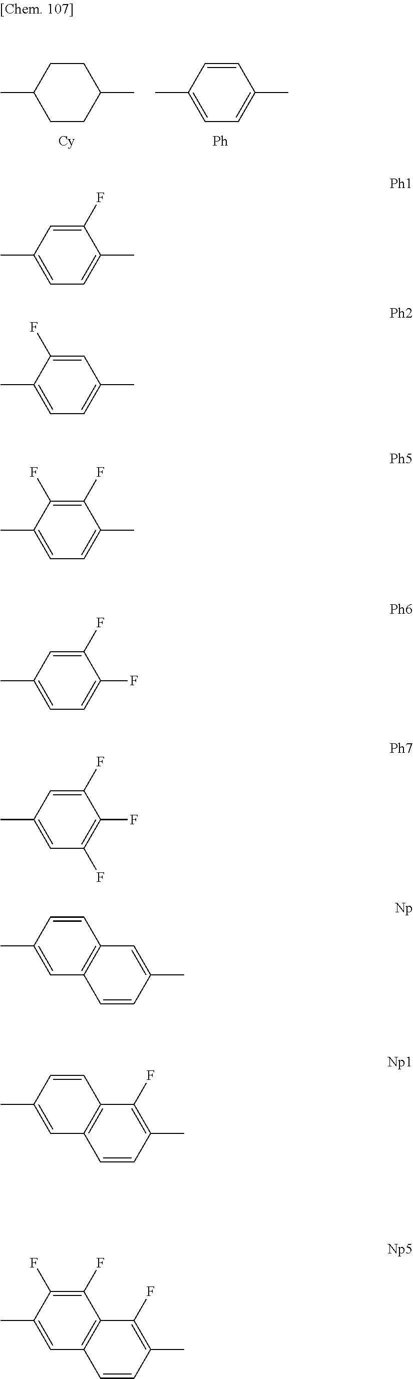

In the examples, the properties measured were as follows.

Tₙᵢ: nematic phase-isotropic liquid phase transition temperature (° C.)

T_{cn}: solid phase-nematic phase transition temperature (° C.)

Δn: refractive index anisotropy at 20° C.

Δε: dielectric anisotropy at 20° C.

η: viscosity at 20° C. (mPa·s)

γ₁: rotational viscosity at 20° C. (mPa·s)

Response speed (τoff/ms):

In measuring the response speed of a sample, test cells respectively having cell thicknesses of 3.2 μm and 3.5 μm and using JALS2096 alignment films were used, Vsel was 5 V, Vnsel was 1 V, the measurement temperature was 20° C., and DMS 301 produced by AUTRONIC-MELCHERS was used. In Examples 1 and 2 and Comparative Examples 1 to 5 described below, the thickness was 3.2 μm. In Examples 3 and 4 and Comparative Examples 6 and 7, the cell thickness was 3.5 μm.

Drop marks:

Drop marks of the liquid crystal display device were evaluated through the following four-grade evaluation by visually observing drop marks that appeared white in an entirely black display,

A: No drop marks (Excellent)

B: Drop marks were slightly observed but were at acceptable level (good)

C: Drop marks were slightly observed and were at the pass/fail borderline level (pass under some conditions)

F: Unacceptable level of drop marks were observed (fail)

### Examples 1 to 6 and Comparative Examples 1 to 7

As shown in Table 1 below, liquid crystal compositions of Examples 1 and 2 and Comparative Examples 1 to 5 were prepared, and their physical property values were measured by using the test cells. The constitutions of the liquid crystal compositions and the results of the physical property values were as shown in Table 1.

Similarly, as shown in Table 2 below, liquid crystal compositions of Examples 3 and 4 and Comparative Examples 6 and 7 were prepared, and their physical property values were measured by using the test cells. The constitutions of the liquid crystal compositions and the results of the physical property values were as shown in Table 2.

Since the response speed cannot be directly compared when the electrooptical properties (Δε, Tni, and Δn) differ, the compositional ratios were adjusted in Examples and Comparative Examples so as to make the electrooptical properties uniform. Moreover, it is needless to mention that the test cells used in Table 1 (Example 1, Example 2, and Comparative Example 1 to 5) have different cell thicknesses from the test cells used in Table 2 (Example 3, Example 4, Comparative Example 6, and Comparative Example 7), and thus their physical property values cannot be simply compared.

TABLE 1

| | | | Compar- | Compar- | Compar- | Compar- | Compar- |
|---|---|---|---|---|---|---|---|
| | | | ative | ative | ative | ative | ative |
| | Example 1 | Example 2 | Example 1 | Example 2 | Example 3 | Example 4 | Example 5 |
| V-Cy-Cy-V | 11 | | 11 | | | | |
| 1V-Cy-Cy-V1 | | 10 | | | | | |
| 3-Cy-Cy-2 | | | | 20 | 19 | | |
| 3-Cy-Cy-4 | | | | 8 | 8 | | |
| 3-Cy-Cy-5 | | | | 5 | 5 | | |
| 3-Cy-Cy-V | 28 | 29 | 22 | | | 28 | 25 |
| 3-Cy-Cy-V1 | | | | | | 3 | 3.5 |
| 5-Ph-Ph-1 | | | | 6.5 | 3 | 6 | 5 |
| 3-Cy-1O-Ph5-O1 | 3 | 9 | | 3 | | 5 | |
| 3-Cy-1O-Ph5-O2 | 12 | 12 | | 12 | | 12 | |
| 3-Cy-Ph5-O2 | | | 12 | | 12 | | 12 |
| 5-Cy-Ph5-O2 | | | 5 | | 5 | | 6 |
| 3-Cy-Cy-Ph-3 | | | 5 | | | 5 | 7 |
| 3-Cy-Ph-Ph-2 | | | | | 3 | | |
| 2-Cy-Cy-1O-Ph5-O2 | 3 | | | 4.5 | | 3 | |
| 3-Cy-Cy-1O-Ph5-O2 | 14 | 12.5 | | 14 | | 14 | |
| 3-Cy-Cy-Ph5-O2 | | | 12 | | 12 | | 12 |
| 4-Cy-Cy-PH5-O2 | | | 7 | | 7 | | 7 |
| 2-Cy-Ph-Ph5-O2 | 7 | 7 | 7 | 7 | 7 | 7 | 7 |
| 3-Cy-Ph-Ph5-O2 | 8 | 8 | 8 | 8 | 8 | 8 | 8 |
| 3-Ph-Ph5-Ph-2 | 7 | 7 | 7 | 7 | 7 | 6 | 5.5 |
| 4-Ph-Ph5-Ph-2 | 7 | 5.5 | 4 | 5 | 4 | 3 | 2 |
| Total | 100 | 100 | 100 | 100 | 100 | 100 | 100 |
| T_{NI}/° C. | 79.3 | 79.1 | 79.8 | 79 | 79.7 | 80.9 | 80.4 |
| Δn | 0.109 | 0.109 | 0.109 | 0.109 | 0.110 | 0.109 | 0.109 |
| nₒ | 1.485 | 1.483 | 1.486 | 1.485 | 1.485 | 1.485 | 1.486 |
| Δε | −3.3 | −3.3 | −3.3 | −3.3 | −3.3 | −3.3 | −3.2 |
| ε_{⊥} | 7.0 | 7.2 | 6.9 | 6.9 | 6.8 | 7.0 | 6.8 |
| η/mPa · s | 17.6 | 20.2 | 19.4 | 23.4 | 25.3 | 19.8 | 20.9 |
| γ₁/mPa · s | 97 | 109 | 125 | 125 | 151 | 114 | 140 |
| γ₁/Δn² | 8.1 | 9.2 | 10.6 | 10.5 | 12.5 | 9.6 | 11.8 |
| Response speed (τ_{off})/ms | 5.1 | 5.7 | 6.5 | 6.5 | 7.8 | 5.9 | 7.3 |
| Drop mark evaluation | A | A | F | A | F | A | F |

TABLE 2

| | | | Compar- | Compar- |
|---|---|---|---|---|
| | | | ative | ative |
| | Example 3 | Example 4 | Example 6 | Example 7 |
| V-Cy-Cy-V | 11 | 11 | 11 | |
| 3-Cy-Cy-2 | | | | 20 |
| 3-Cy-Cy-4 | | | | 8 |
| 3-Cy-Cy-5 | | | | 5 |
| 3-Cy-Cy-V | 28 | 28 | 26 | |
| 5-Ph-Ph-1 | 3 | 2 | | 5 |
| 3-Cy-1O-Ph5-O1 | 3 | 3 | | |
| 3-Cy-1O-Ph5-O2 | 12 | 11 | | |
| 3-Cy-Ph5-O2 | | | 12 | 12 |
| 5-Cy-Ph5-O2 | | | 5 | 5 |
| 3-Cy-Cy-Ph-3 | | 4 | 3 | 4 |
| 3-Cy-Ph-Ph-2 | 2 | | 2 | |
| 2-Cy-Cy-1O-Ph5-O2 | 5 | 5 | | |
| 3-Cy-Cy-1O-Ph5-O2 | 14 | 14 | | |
| 3-Cy-Cy-Ph5-O2 | | | 12 | 12 |
| 4-Cy-Cy-Ph5-O2 | | | 7 | 7 |
| 2-Cy-Ph-Ph5-O2 | 7 | 7 | 7 | 7 |
| 3-Cy-Ph-Ph5-O2 | 8 | 8 | 8 | 8 |
| 3-Cy-Ph-Ph5-O3 | 7 | | 7 | 7 |
| 3-Ph-A-Ph-Ph5-O2 | | 7 | | |
| Total | 100 | 100 | 100 | 100 |
| T_{NI}/° C. | 80.9 | 80.9 | 81.2 | 80.6 |
| Δn | 0.095 | 0.096 | 0.095 | 0.095 |
| nₒ | 1.481 | 1.482 | 1.482 | 1.481 |
| Δε | −3.3 | −3.3 | −3.3 | −3.2 |
| ε_{⊥} | 7.0 | 6.8 | 6.8 | 6.7 |
| η/mPa · s | 16.9 | 15.1 | 18 | 22.8 |
| γ₁/mPa · s | 94 | 98 | 114 | 140 |
| γ₁/Δn² | 10.4 | 10.7 | 12.6 | 15.6 |
| Response speed (τ_{off})/ms | 6.4 | 6.6 | 7.8 | 9.7 |
| Drop mark evaluation | A | A | F | F |

The liquid crystal compositions of Examples 1 and 2 according to the present invention had lower viscosity (η), lower rotational viscosity (γ₁), short response speed than the comparative examples, and no drop marks were observed. In Examples 3 and 4, the viscosity (η) was low, the rotational viscosity (γ₁) was low, the response speed was short, and no drop marks were observed.

In view of the above, it was confirmed that because the liquid crystal composition of the present invention is a composition that has sufficiently low viscosity (η), sufficiently low rotational viscosity (γ₁), high response speed, and negative dielectric anisotropy (Δε) without degrading the refractive index anisotropy (Δn) and the nematic phase-isotropic liquid phase transition temperature (Tₙᵢ), a liquid crystal display device that uses the liquid crystal composition has high display quality and excellent response speed.

1. A liquid crystal composition comprising:
one or two or more compounds represented by general formula (i): 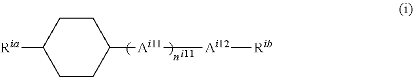
(in general formula (i), R^{ia} and R^{ib} each independently represent an alkenyl group having 2 to 8 carbon atoms,
Aⁱ¹¹ and Aⁱ¹² each independently represent a group selected from the group consisting of group (a) and group (b) below:
(a) a 1,4-cyclohexylene group (one —CH₂— or two or more non-adjacent —CH₂— present in this group may each be substituted with —O—)
(b) a 1,4-phenylene group (one —CH═ or two or more non-adjacent —CH═ present in this group may each be substituted with —N═)
where the group (a) and the group (b) may each independently be substituted with a cyano group, a fluorine atom, or a chlorine atom, and
nⁱⁱ¹¹ represents an integer of 0 to 3, and when nⁱ¹¹ represents 2 or 3 and multiple Aⁱ¹¹ are present, they may be the same or different); and
one or two or more compounds represented by general formula (ii): 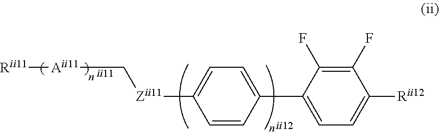
(in general formula (ii), Rⁱⁱ¹¹ and Rⁱⁱ¹² each independently represent an alkyl group having 1 to 8 carbon atoms, one —CH₂— or two or more non-adjacent —CH₂— in the alkyl group may each independently be substituted with —CH═CH—, —OC—, —O—, —CO—, —COO—, or OCO—,
Aⁱⁱ¹¹ represents a group selected from the group consisting of group (a) and group (b) below:
(a) a 1,4-cyclohexylene group (one —CH₂— or two or more non-adjacent —CH₂— present in this group may each be substituted with —O—)
(b) a 1,4-phenylene group (one —CH═ or two or more non-adjacent —CH═ present in this group may each be substituted with —N═)
where the group (a) and the group (b) may each independently be substituted with a cyano group, a fluorine atom, or a chlorine atom,
Zⁱⁱ¹¹ represents —CH₂— or —O—;
nⁱⁱ¹¹ represents an integer of 0 to 3, and
nⁱⁱ¹² represents an integer of 0 to 3, and when nⁱⁱ¹¹ represents 2 or 3 and multiple Aⁱ¹¹ are present, they may be the same or different).

2. The liquid crystal composition according to claim 1, further comprising one or two or more compounds selected from compounds represented by general formulae (N-1), (N-2), and (N-3): 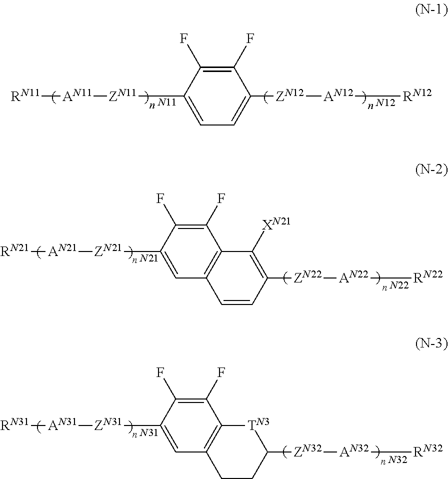
(in the formulae, R^{N11}, R^{N12}, R^{N21}, R^{N22}, R^{N31}, and R^{N32} each independently represent an alkyl group having 1 to 8 carbon atoms, one —CH₂— or two or more non-adjacent —CH₂— in the alkyl group may each independently be substituted with —CH═CH—, —OC—, —O—, —CO—, —COO—, or OCO—,
A^{N11}, A^{N12}, A^{N21}, A^{N22}, A^{N31}, and A^{N32} each independently represent a group selected from the group consisting of group (a), group (b), and group (c) below:
(a) a 1,4-cyclohexylene group (one —CH₂— or two or more non-adjacent —CH₂— present in this group may each be substituted with —O—),
(b) a 1,4-phenylene group (one —CH═ or two or more non-adjacent —CH═ present in this group may each be substituted with —N═), and
(c) (c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═ present in the naphthalene-2,6-diyl group or the 1,2,3,4-tetrahydronaphthalene-2,6-diyl group may each be substituted with —N═),
where the group (a), the group (b), and the group (c) may each independently be substituted with a cyano group, a fluorine atom, or a chlorine atom,
Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or C≡C—,
X^{N21} represents a hydrogen atom or a fluorine atom,
T^{N31} represents —CH₂— or an oxygen atom,
n^{N11}, n^{N12}, n^{N21}, n^{N22}, n^{N31}, and n^{N32} each independently represent an integer of 0 to 3, n^{N11}+n^{N12}, n^{N21}+n^{N22}, and n^{N31}+n^{N32} are each independently 1, 2, or 3, and when n^{N11}, n^{N12}, n^{N21}, n^{N22}, n^{N31}, and n^{N32} each independently represent 2 or 3 and multiple A^{N11} to A^{N32} and multiple Z^{N11} to Z^{N32} are present, they may be the same or different; however, from the compounds represented by general formula (N-1), compounds represented by general formula (i), general formula (ii), general formula (N-2), and general formula (N-3) are excluded, and from the compounds represented by general formula (N-2), compounds represented by general formula (N-3) are excluded).

3. The liquid crystal composition according to claim 1, further comprising one or two or more compounds selected from compounds represented by general formula (L):
R^{L1}-A^{L1}-Z^{L1}A^{L2}-Z^{L2}ₙ_{^{L1}}A^{L3}-R^{L2} (L)
(in the formula, R^{L1} and R^{L2} each independently represent an alkyl group having 1 to 8 carbon atoms, one —CH₂— or two or more non-adjacent —CH₂— in the alkyl group may each independently be substituted with —CH═CH—, —C≡C—, —O—, —CO—, —COO—, or OCO—,
n^{L1} represents 0, 1, 2, or 3,
A^{L1}, A^{L2}, and A^{L3} each independently represent a group selected from the group consisting of
(a) a 1,4-cyclohexylene group (one —CH₂— or two or more non-adjacent —CH₂— present in this group may each be substituted with —O—) and
(b) a 1,4-phenylene group (one —CH═ or two or more non-adjacent —CH═ present in this group may each be substituted with —N═)
(c) (c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═ present in the naphthalene-2,6-diyl group or the 1,2,3,4-tetrahydronaphthalene-2,6-diyl group may each be substituted with —N═),
where the group (a), the group (b), and the group (c) may each independently be substituted with a cyano group, a fluorine atom, or a chlorine atom,
Z^{L1} and Z^{L2} each independently represents a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or C≡C—, and
when n^{L1} represents 2 or 3 and multiple A^{L2} are present, they may be the same or different, and when n^{L1} represents 2 or 3 and multiple Z^{L3} are present, they may be the same or different; however, compounds represented by general formula (i), general formula (ii), general formula (N-1), general formula (N-2), and general formula (N-3) are excluded).

4. The liquid crystal composition according to claim 1, comprising a polymerizable compound.

5. A liquid crystal display device that uses the liquid crystal composition according to claim 1.

6. The liquid crystal display device according to claim 4, comprising a liquid crystal layer obtained by polymerizing the polymerizable compound.

7. An active matrix driving liquid crystal display device that uses the liquid crystal composition according to claim 1.

8. A liquid crystal display device of VA mode, PSA mode, PSVA mode, IPS mode, FFS mode, or ECB mode, the device using the liquid crystal composition according to claim 1.
